(19) United States
(12) Patent Application Publication
(10) Pub. No.: US 2024/0250733 A1
(43) Pub. Date: Jul. 25, 2024

(54) GENERATING A UCI BIT SEQUENCE FOR CSI REPORTING UNDER MULTI-TRP TRANSMISSION

(71) Applicant: Lenovo (Singapore) Pte. Ltd., New Tech Park (SG)

(72) Inventors: Ahmed Hindy, Aurora, IL (US); Vijay Nangia, Woodridge, IL (US)

(21) Appl. No.: 18/563,077

(22) PCT Filed: May 23, 2022
(86) PCT No.: PCT/IB2022/054814

§ 371 Date: Nov. 21, 2023

Related U.S. Application Data
(60) Provisional application No. 63/191,840, filed on May 21, 2021.

(51) Int. Cl. H04B 7/06; H04B 7/024; H04L 5/00

(52) U.S. Cl. CPC H04B 7/0626; H04B 7/024; H04L 5/0051

(57) ABSTRACT

Apparatuses, methods, and systems are disclosed for generating a UCI bit sequence for CSI reporting under multi-TRP transmission. An apparatus (1300) includes a transceiver (1325) that receives a channel state information (“CSI”) reporting setting associated with one or more CSI resource settings, and one or more non-zero power (“NZP”) CSI reference signal (“CSI-RS”) resources for channel measurement transmitted from one or more transmission points in the network. The apparatus (1300) includes a processor (1305) that generates a CSI report comprising CSI corresponding to at least a subset of CSI indicator types, each CSI indicator type corresponding to at least one transmission hypothesis of a joint transmission hypothesis, a first single-point transmission hypothesis, and a second single-point transmission hypothesis, and at least one segment comprising values of the subset of the CSI indicator types that are ordered in an order of at least one transmission hypothesis.

### CROSS-REFERENCE TO RELATED APPLICATIONS

This application claims priority to U.S. Provisional Patent Application No. 63/191,840 entitled “APPARATUSES, METHODS, AND SYSTEMS FOR GENERATING UCI BIT SEQUENCE FOR CSI REPORTING UNDER MULTI-TRP TRANSMISSION” and filed on May 21, 2021, for Ahmed Hindy, et al., which is incorporated herein by reference.

### FIELD

The subject matter disclosed herein relates generally to wireless communications and more particularly relates to generating an uplink control information (“UCI”) bit sequence for channel state information (“CSI”) reporting under transmission involving multiple transmit-receive points (“TRPs”).

### BACKGROUND

For Third Generation Partnership Project (“3GPP”) new radio (“NR”), multiple TRPs or multi-antenna panels within a TRP may communicate simultaneously with one user equipment (“UE”) to enhance coverage, throughput, and reliability. This may come at the expense of excessive control signaling between the network side and the UE side, to communicate the best transmission configuration, e.g., whether to support multi-point transmission, and if so, which TRPs would operate simultaneously, in addition to a possibly super-linear increase in the amount of CSI feedback reported from the UE to the network, since a distinct report may be needed for each transmission configuration.

### BRIEF SUMMARY

Apparatuses for generating a UCI bit sequence for CSI reporting under multi-TRP transmission. Methods and systems also perform the functions of the apparatus.

A first apparatus, in one embodiment, includes a transceiver that receives, from a network, a CSI reporting setting associated with one or more CSI resource settings and receives, from one or more transmission points in the network, one or more non-zero power (“NZP”) CSI reference signal (“CSI-RS”) resources for channel measurement. In one embodiment, the first apparatus includes a processor that generates a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis. In one embodiment, the transceiver transmits the generated CSI report to the network.

A first method, in one embodiment, receives, from a network, a CSI reporting setting associated with one or more CSI resource settings and receives, from one or more transmission points in the network, one or more NZP CSI-RS resources for channel measurement. In one embodiment, the first method generates a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis. In one embodiment, the first method transmits the generated CSI report to the network.

In one embodiment, a second apparatus includes a transceiver that transmits, to a UE, a CSI reporting setting associated with one or more CSI resource settings. In one embodiment, the transceiver transmits, to the UE from one or more transmission points, one or more NZP CSI-RS resources for channel measurement. In one embodiment, the transceiver receives, from the UE, a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.

In one embodiment, a second method transmits, to a UE, a CSI reporting setting associated with one or more CSI resource settings. In one embodiment, the transceiver transmits, to the UE from one or more transmission points, one or more NZP CSI-RS resources for channel measurement. In one embodiment, the transceiver receives, from the UE, a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for generating a UCI bit sequence for CSI reporting under multi-TRP transmission:

FIG. 2 is a diagram illustrating one embodiment of multiple transmit/receive points in a coordination cluster connected to a central processing unit (“CPU”) for generating a UCI bit sequence for CSI reporting under multi-TRP transmission:

FIG. 3 is a diagram illustrating one embodiment of aperiodic trigger state defining a list of CSI report settings for generating a UCI bit sequence for CSI reporting under multi-TRP transmission:

FIG. 4 is a code sample illustrating one embodiment of the process by which an aperiodic trigger state indicates a resource set and quasi-co-location (“QCL”) information for generating a UCI bit sequence for CSI reporting under multi-TRP transmission:

FIG. 5 is a code sample illustrating one embodiment of a radio resource control (“RRC”) configuration including an NZP-CSI-RS resource and a CSI interference management (“CSI-IM”) resource for generating a UCI bit sequence for CSI reporting under multi-TRP transmission:

FIG. 6 is a schematic block diagram illustrating one embodiment of a partial CSI omission for physical uplink shared channel (“PUSCH”)-based CSI for CSI reporting for generating a UCI bit sequence for CSI reporting under multi-TRP transmission;

FIG. 7 depicts one embodiment of ASN.1 code for CSI-ReportConfig Reporting Setting information element (“IE”) with multi-TRP transmission indication;

FIG. 8 depicts one embodiment of ASN.1 code for triggering more than one CSI Report within CSI-ReportConfig Reporting Setting IE;

FIG. 9 depicts one embodiment of ASN.1 code for triggering two CSI Reports within CodebookConfig Codebook Configuration IE;

FIG. 10 depicts one embodiment of ASN.1 code for triggering two CSI Reports within CSI-ReportConfig Reporting Setting IE;

FIG. 11 depicts one embodiment of ASN.1 code for triggering two CSI Reports within CSI-ReportConfig Reporting Setting IE;

FIG. 12 depicts one embodiment of ASN.1 code for proposed RepetitionSchemeConfig Repetition Scheme Configuration IE;

FIG. 13 is a block diagram illustrating one embodiment of a user equipment apparatus that may be used for generating a UCI bit sequence for CSI reporting under multi-TRP transmission;

FIG. 14 is a block diagram illustrating one embodiment of a network apparatus that may be used for generating a UCI bit sequence for CSI reporting under multi-TRP transmission;

FIG. 15 is a flowchart diagram illustrating one embodiment of a method for generating a UCI bit sequence for CSI reporting under multi-TRP transmission; and

FIG. 16 is a flowchart diagram illustrating one embodiment of another method for generating a UCI bit sequence for CSI reporting under multi-TRP transmission.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

For 3GPP NR, multiple TRPs or multi-antenna panels within a TRP may communicate simultaneously with one UE to enhance coverage, throughput, and reliability. This comes at the expense of excessive control signaling between the network side and the UE side, so as to communicate the best transmission configuration, e.g., whether to support multi-point transmission, and if so, which TRPs would operate simultaneously, in addition to a possibly super-linear increase in the amount of CSI feedback reported from the UE to the network, since a distinct report may be needed for each transmission configuration.

For Rel. 16 Type-II codebook with high resolution, the number of precoding matrix indicator (“PMI”) bits fed back from the UE in the gNB via UCI can be very large (>1000 bits at large bandwidth), even for a single-point transmission. Thereby, reducing the number of PMI feedback bits per report is crucial to improve efficiency. The multiple input-multiple output (“MIMO”) enhancements in NR Rel. 16 MIMO work item included multi-TRP and multi-panel transmissions. The purpose of multi-TRP transmission is to improve the spectral efficiency, as well as the reliability and robustness of the connection in different scenarios, and it covers both ideal and nonideal backhaul. For increasing the reliability using multi-TRP, ultra-reliable low latency communications (“URLLC”) under multi-TRP transmission may be used, where the UE can be served by multiple TRPs forming a coordination cluster, possibly connected to a CPU.

In this disclosure, apparatuses, methods, and systems are proposed to address different CSI reporting enhancements for multi-TRP transmission, focusing on UCI bit sequence generation for CSI reporting under multi-TRP CSI framework. Further, the issue of CSI reports collision is addressed for multi-TRP CSI framework, wherein one CSI Reporting Setting triggers more than one CSI Report.

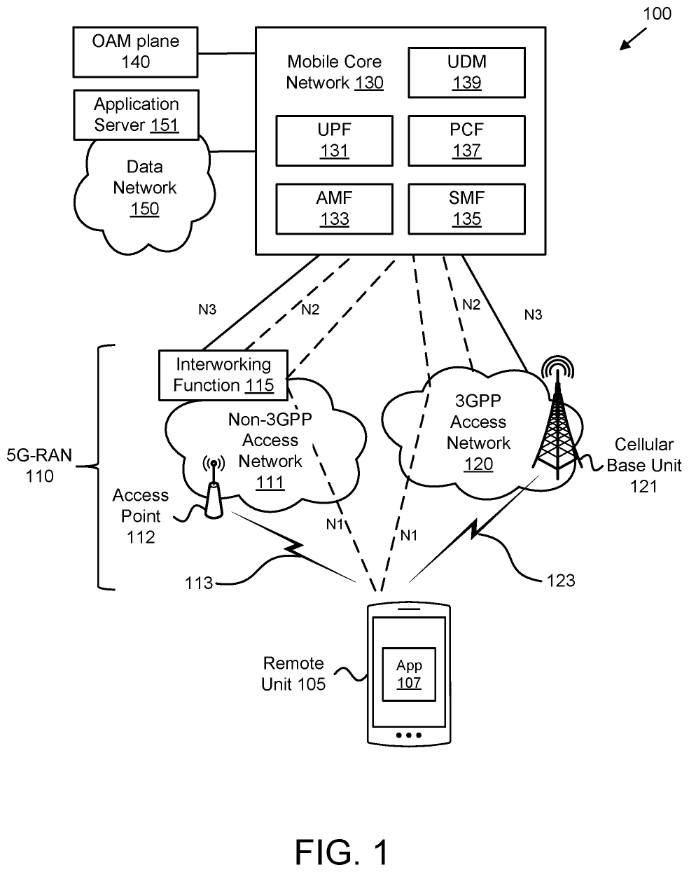

FIG. 1 depicts a wireless communication system 100 supporting generating a UCI bit sequence for CSI reporting under multi-TRP transmission, according to embodiments of the disclosure. In one embodiment, the wireless communication system 100 includes at least one remote unit 105, a radio access network (“RAN”) 110 (e.g., a 5G RAN), and a mobile core network 130. The RAN 110 and the mobile core network 130 form a mobile communication network. The RAN 110 may be composed of a base unit 121. Even though a specific number of remote units 105, RANs 110, and mobile core networks 130 are depicted in FIG. 1, one of skill in the art will recognize that any number of remote units 105, RANs 110, and mobile core networks 130 may be included in the wireless communication system 100.

The 5G-(R)AN 110 may be composed of a 3GPP access network 120 containing at least one cellular base unit 121 and/or a non-3GPP access network 111 containing at least one access point 112. Here, the RAN 110 is an intermediate network that provides the remote units 105 with access to the mobile core network 130.

In one implementation, the 3GPP access network 120 that is compliant with the Fifth-Generation (“5G”) system specified in the 3GPP specifications. For example, the 3GPP access network 120 may be a New Generation Radio Access Network (“NG-RAN”), implementing NR Radio Access Technology (“RAT”) and/or 3GPP Long-Term Evolution (“LTE”) RAT. In another example, the 3GPP access network 120 may include non-3GPP RAT (e.g., Wi-Fi® or Institute of Electrical and Electronics Engineers (“IEEE”) 802.11-family compliant WLAN). In another implementation, the 3GPP access network 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with the base units 121 in the 3GPP access network 120 via uplink (“UL”) and/or downlink (“DL”) communication signals. Furthermore, the UL and DL communication signals may be carried over the 3GPP wireless communication links 123. Additionally (or alternatively), the remote units 105 may communicate directly with the access points 112 in the non-3GPP access network 111 via UL and/or DL communication signals, which may be carried over the non-3GPP communication links 113.

In some embodiments, the remote units 105 communicate with an application server 151 via a network connection with the mobile core network 130. For example, an application 107 (e.g., web browser, media client, email client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 110. The mobile core network 130 then relays traffic between the remote unit 105 and the application server 151 (e.g., a content server in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as ““attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QOS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, for example the 3GPP access network 120, that may include one or more controllers communicably coupled to one or more corresponding base units 121. These and other elements of radio access network are not illustrated but are well known generally by those having ordinary skill in the art. The base units 121 connect to the mobile core network 130 via the RAN.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR in Unlicensed Spectrum (“NR-U”) operation, the base unit 121 and the remote unit 105 communicate over unlicensed radio spectrum.

The non-3GPP access networks 111 may be distributed over a geographic region. Each non-3GPP access network 111 may serve a number of remote units 105 with a serving area. Typically, a serving area of the non-3GPP access network 111 is smaller than the serving area of a cellular base unit 121. An access point 112 in a non-3GPP access network 111 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 113. The 3GPP communication links 123 and non-3GPP communication links 113 may employ different frequencies and/or different communication protocols. In various embodiments, an access point 112 may communicate using unlicensed radio spectrum. The mobile core network 130 may provide services to a remote unit 105 via the non-3GPP access networks 111, as described in greater detail herein.

In some embodiments, a non-3GPP access network 111 connects to the mobile core network 130 via an interworking function 115. The interworking function 115 provides interworking between the remote unit 105 and the mobile core network 130. In some embodiments, the interworking function 115 is a Non-3GPP Interworking Function (“N3IWF”) and, in other embodiments, it is a Trusted Non-3GPP Gateway Function (“TNGF”). The N3IWF supports the connection of “untrusted” non-3GPP access networks to the mobile core network (e.g., 5GC), whereas the TNGF supports the connection of “trusted” non-3GPP access networks to the mobile core network. The interworking function 115 supports connectivity to the mobile core network 130 via the “N2” and “N3” interfaces, and it relays “N1” signaling between the remote unit 105 and the AMF 143. As depicted, both the 3GPP access network 120 and the interworking function 115 communicate with the AMF 143 using a “N2” interface. The interworking function 115 also communicates with the UPF 141 using a “N3” interface.

In certain embodiments, a non-3GPP access network 111 may be controlled by an MNO of the mobile core network 130 and may have direct access to the mobile core network 130. Such a non-3GPP AN deployment is referred to as a “trusted non-3GPP access network.” A non-3GPP access network 111 is considered as “trusted” when it is operated by the MNO, or a trusted partner, and supports certain security features, such as strong air-interface encryption. In contrast, a non-3GPP AN deployment that is not controlled by an operator (or trusted partner) of the mobile core network 130, does not have direct access to the mobile core network 130, or does not support the certain security features is referred to as a “non-trusted” non-3GPP access network.

In one embodiment, the mobile core network 130 is a 5G Core network (“5GC”) or an Evolved Packet Core network (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Policy Control Function (“PCF”) 137, a Unified Data Management function (“UDM”) and a User Data Repository (“UDR”).

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The PCF 137 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

The Operations, Administration and Maintenance (“OAM”) plane 140 is involved with the operating, administering, managing and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM plane 140 may also be involved with provisioning, i.e., the setting up of the user accounts, devices and services.

While FIG. 1 depicts components of a 5G RAN and a 5G core network, the described embodiments apply to other types of communication networks and RATs, including IEEE 802.11 variants, Global System for Mobile Communications (“GSM,” i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR/5G BS, etc. Further the operations are described mainly in the context of 5G NR. However, the described solutions/methods are also equally applicable to other mobile communication systems supporting generating a UCI bit sequence for CSI reporting under multi-TRP transmission.

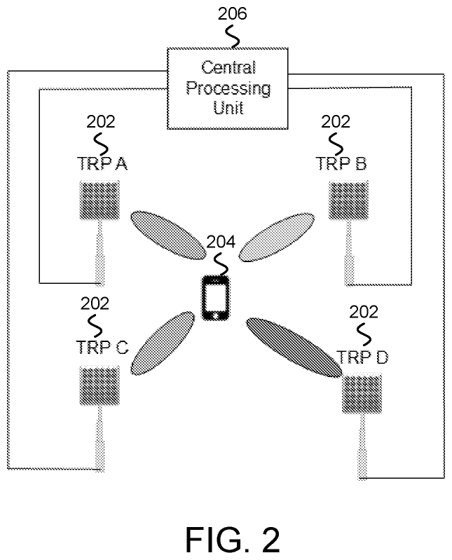

As described above, in one embodiment, for 3GPP NR, multiple TRPs or multi-antenna panels within a TRP may communicate simultaneously with one UE to enhance coverage, throughput, and reliability. This comes at the expense of excessive control signaling between the network side and the UE side, to communicate the best transmission configuration, e.g., whether to support multi-point transmission, and if so, which TRPs would operate simultaneously, in addition to a possibly super-linear increase in the amount of CSI feedback reported from the UE to the network, since a distinct report may be needed for each transmission configuration. For Rel. 16 Type-II codebook with high resolution, the number of PMI bits fed back from the UE in the gNB via UCI can be very large (>1000 bits at large bandwidth), even for a single-point transmission. Thereby, reducing the number of PMI feedback bits per report is crucial to improve efficiency. The MIMO enhancements in NR Rel. 16 MIMO work item included multi-TRP and multi-panel transmissions. The purpose of multi-TRP transmission is to improve the spectral efficiency, as well as the reliability and robustness of the connection in different scenarios, and it covers both ideal and nonideal backhaul. For increasing the reliability using multi-TRP, URLLC under multi-TRP transmission was agreed, where the UE can be served by multiple TRPs forming a coordination cluster, possibly connected to a CPU, as shown in FIG. 2.

In one scenario, the UE 204 can be dynamically scheduled to be served by one of multiple TRPs 202 in the cluster (e.g., baseline Rel. 15 NR scheme). The network can also pick two TRPs 202 to perform joint transmission. In either case, the UE 204 needs to report the needed CSI information for the network for it to decide the mTRP DL transmission scheme.

However, in one embodiment, the number of transmission hypotheses increases exponentially with number of TRPs in the coordination cluster. For example, for 4 TRPs, you have 10 transmission hypotheses: (TRP 1), (TRP 2), (TRP 3), (TRP 4), (TRP 1, TRP 2), (TRP 1, TRP 3), (TRP 1, TRP 4), (TRP 2, TRP 3), (TRP 2, TRP 4), and (TRP 3, TRP 4). The overhead from reporting will increase dramatically with the size of the coordination cluster. In general, the presence of K TRPs can trigger up to

$$K + ( \begin{matrix}K \\ n\end{matrix} ) ,$$

where

$$( \begin{matrix}K \\ n\end{matrix} )$$

represents the binomial coefficient representing the number of possible unordered n-tuples selected from a set of K elements, where n≤K.

Moreover, the UL transmission resources on which the CSI reports are transmitted might not be enough, and partial CSI omission might be necessary as the case in Rel. 16. Currently CSI reports are prioritized according to:
Time-domain behavior and physical channel, where more dynamic reports are given precedence over less dynamic reports and PUSCH has precedence over physical uplink control channel (“PUCCH”).
·CSI content, where beam reports (i.e. L1-reference signal received power (“RSRP”) reporting) has priority over regular CSI reports.
The serving cell to which the CSI corresponds (in case of CA operation). CSI corresponding to the PCell has priority over CSI corresponding to SCells.
The CSI Report Setting ID reportConfigID.

The subject matter disclosed herein, for the purpose of multi-TRP transmission with either single-downlink control information (“DCI”) or multi-DCI, helps achieve the following:
Discuss the decomposition of a CSI report under multi-TRP CSI reporting framework; and
Provide details on the UCI bit allocation for CSI reporting corresponding to multi-TRP transmission

Regarding NR Codebook Types (details of which can be found in 3GPP TS 38.214), a summary is provided below.

For NR Rel. 15 Type-II Codebook, assume the gNB is equipped with a two-dimensional (“2D”) antenna array with N1. N2 antenna ports per polarization placed horizontally and vertically and communication occurs over N3 PMI sub-bands. A PMI sub-band consists of a set of resource blocks, each resource block consisting of a set of subcarriers. In such case, 2N₁N₂

CSI-reference signal (“RS”) ports are utilized to enable DL channel estimation with high resolution for NR Type-II codebook. To reduce the UL feedback overhead, a Discrete Fourier transform (“DFT”)-based CSI compression of the spatial domain is applied to L dimensions per polarization, where L<N₁N₂. The magnitude and phase values of the linear combination coefficients for each sub-band are fed back to the gNB as part of the CSI report. The 2N₁N₂×N₃codebook per layer takes on the form

$$W = {W}_{1} {W}_{2} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} - 1 , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript T denotes a matrix transposition operation. Note that 01, 02 oversampling factors are assumed for the 2D DFT matrix from which matrix B is drawn. Note that W₁ is common across all layers. W₂ is a 2Lx N3 matrix, where the i^{th} column corresponds to the linear combination coefficients of the 2L beams in the i^{th} sub-band. Only the indices of the L selected columns of B are reported, along with the oversampling index taking on 0102 values. Note that W₂ are independent for different layers.

For NR Rel. 15 Type-II Port Selection codebook, in one embodiment, only K (where K≤2N₁N₂) beamformed CSI-RS ports are utilized in DL transmission, in order to reduce complexity. The K×N₃ codebook matrix per layer takes on the form:

$$W = {W}_{1}^{PS} {W}_{2} .$$

Here, W₂ follow the same structure as the conventional NR Rel. 15 Type-II Codebook and are layer specific. W₁^{PS} is a K×2L block-diagonal matrix with two identical diagonal blocks, i.e.,

$${W}_{1}^{PS} = [ \begin{matrix}E & 0 \\ 0 & E\end{matrix} ] ,$$

### and E is a

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where eᵢ^{(K)} is a standard unit vector with a 1 at the i^{th} location. Here d_{PS} is an RRC parameter which takes on the values {1,2,3,4} under the condition d_{PS}≤ min(K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . ,7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

$$[ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, in one embodiment, m_{PS} parametrizes the location of the first 1 in the first column of E, whereas d_{PS} represents the row shift corresponding to different values of m_{PS}.

In one embodiment, NR Type-I codebook is the baseline codebook for NR, with a variety of configurations. The most common utility of Type-I codebook is a special case of NR Type-II codebook with L=1 for RI=1, 2, wherein a phase coupling value is reported for each sub-band, i.e., W₂ is 2×N₃, with the first row equal to [1, 1, . . . , 1] and the second row equal to [e^{j2πØ}^{₀}, . . . , e^{j2πØ}^{_{N3-1}}]. Under specific configurations, ϕ₀=ϕ₁ . . . =ϕ. i.e., wideband reporting. For RI>2 different beams are used for each pair of layers. Obviously, NR Type-I codebook can be depicted as a low-resolution version of NR Type-II codebook with spatial beam selection per layer-pair and phase combining only.

Regarding NR Rel. 161 Type-II codebook, in one embodiment, assume the gNB is equipped with a two-dimensional (“2D”) antenna array with N₁, N₂ antenna ports per polarization placed horizontally and vertically and communication occurs over N3 PMI sub-bands. A PMI sub-band consists of a set of resource blocks, each resource block consisting of a set of subcarriers. In such case, 2N₁N₂N₃ CSI-RS ports are utilized to enable DL channel estimation with high resolution for NR Rel. 16 Type-II codebook. To reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$$W = {W}_{1} {\tilde{W}}_{2} {W}_{f}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} - 1 ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} - 1 ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically sampled size-N₃ DFT matrix, as follows

$${W}_{f} = [ \begin{matrix}{f}_{{k}_{0}} & {f}_{{k}_{1}} & … & {f}_{{k}_{{M}^{′} - 1}}\end{matrix} ] , 0 \leq {k}_{i} < {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

The indices of the L selected columns of B are reported, along with the oversampling index taking on O₁O₂ values. Similarly, for W_{F}, only the indices of the M selected columns out of the predefined size-N₃ DFT matrix are reported. In the sequel the indices of the M dimensions are referred as the selected Frequency Domain (“FD”) basis indices. Hence, L, M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap. Since all coefficients reported within a layer are normalized with respect to the coefficient with the largest magnitude (strongest coefficient), the relative value of that coefficient is set to unity, and no magnitude or phase information is explicitly reported for this coefficient. Only an indication of the index of the strongest coefficient per layer is reported. Hence, for a single-layer transmission, magnitude and phase values of a maximum of [2βLM]−1 coefficients (along with the indices of selected L, M DFT vectors) are reported per layer, leading to significant reduction in CSI report size, compared with reporting 2N₁N₂×N₃−1 coefficients' information.

Regarding NR Rel. 16 Type II Port Selection Codebook, only K (where K≤2N₁N₂) beamformed CSI-RS ports are utilized in DL transmission, to reduce complexity. The K×N₃ codebook matrix per layer takes on the form:

$$W = {W}_{1}^{PS} {\tilde{W}}_{2} {W}_{f}^{H}$$

Here, \tilde{W}₂ and W₃ follow the same structure as the conventional NR Rel. 16 Type-II Codebook, where both are layer specific. The matrix W₁^{PS} is a K×2L block-diagonal matrix with the same structure as that in the NR Rel. 15 Type-II Port Selection Codebook.

Regarding codebook reporting, in one embodiment, the codebook report is partitioned into two parts based on the priority of information reported. Each part is encoded separately (Part 1 has a possibly higher code rate). Below are parameters for NR Rel. 16 Type-II codebook:
Part 1: RI+CQI+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, in one embodiment, Part 2 CSI can be decomposed into sub-parts each with different priority (higher priority information listed first). Such partitioning is required to allow dynamic reporting size for codebook based on available resources in the UL phase.

Also Type-II codebook, in one embodiment, is based on aperiodic CSI reporting, and only reported in PUSCH via DCI triggering (one exception). Type-I codebook can be based on periodic CSI reporting (PUCCH) or semi-persistent CSI reporting (PUSCH or PUCCH) or aperiodic reporting (PUSCH).

Regarding priority reporting for part 2 CSI, in one embodiment, multiple CSI reports may be transmitted, as shown in Table 1 below:

TABLE 1
CSI Reports priority ordering

Priority 0:
For CSI reports 1 to N_{Rep}, Group 0 CSI for CSI reports configured as ‘typeII-r16’ or
‘typeII-PortSelection-r16’; Part 2 wideband CSI for CSI reports configured otherwise
Priority 1:
Group 1 CSI for CSI report 1, if configured as ‘typeII-r16’ or ‘typeII-PortSelection-
r16’; Part 2 sub-band CSI of even sub-bands for CSI report 1, if configured otherwise
Priority 2:
Group 2 CSI for CSI report 1, if configured as ‘typeII-r16’ or ‘typeII-PortSelection-
r16’; Part 2 sub-band CSI of odd sub-bands for CSI report 1, if configured otherwise
Priority 3:
Group 1 CSI for CSI report 2, if configured as ‘typeII-r16’ or ‘typeII-PortSelection-
r16’; Part 2 sub-band CSI of even sub-bands for CSI report 2, if configured otherwise
Priority 4:
Group 2 CSI for CSI report 2, if configured as ‘typeII-r16’ or ‘typeII-PortSelection-
r16’. Part 2 sub-band CSI of odd sub-bands for CSI report 2, if configured otherwise
.
.
.
Priority 2N_{Rep} − 1:
Group 1 CSI for CSI report N_{Rep}, if configured as ‘typeII-r16’ or ‘typeII-
PortSelection-r16’; Part 2 sub-band CSI of even sub-bands for CSI report N_{Rep}, if
configured otherwise
Priority 2N_{Rep}:
Group 2 CSI for CSI report N_{Rep}, if configured as ‘typeII-r16’ or ‘typeII-
PortSelection-r16’; Part 2 sub-band CSI of odd sub-bands for CSI report N_{Rep}, if
configured otherwise
Note that the priority of the NRep CSI reports are based on the following:
A CSI report corresponding to one CSI reporting configuration for one cell may have higher priority compared with another CSI report corresponding to one other CSI reporting configuration for the same cell;
CSI reports intended to one cell may have higher priority compared with other CSI reports intended to another cell;
CSI reports may have higher priority based on the CSI report content, e.g., CSI reports carrying L1-RSRP information have higher priority; and
CSI reports may have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower IDs have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Ms: Maximum number of CSI reporting configurations
c: Cell index, and N_{cells}: Number of serving cells
k: 0 for CSI reports carrying L1-RSRP or L1-SINR, 1 otherwise
y: 0 for aperiodic reports, 1 for semi-persistent reports on PUSCH, 2 for semi-persistent reports on PUCCH, 3 for periodic reports.

Regarding triggering aperiodic CSI reporting on PUSCH, in one embodiment, for multi-TRP URLLC transmission, five schemes have been agreed in Rel. 16:
Scheme 1a (subscriber data management (“SDM”)): two TRPs transmit a physical downlink shared channel (“PDSCH”) with overlapped time and frequency resource within a single slot:
Scheme 2a (frequency division multiplexing (“FDM”)): two TRPs transmit a PDSCH with one redundancy version (“RV”) across non-overlapping comb-like frequency resources assigned to different TRPs within a single slot:
Scheme 2b (FDM): two TRPs transmit a PDSCH with different RVs across non-overlapping comb-like frequency resources assigned to different TRPs within a single slot:
Scheme 3 (time division multiplexing (“TDM”)): two TRPs transmit up to 2 TDMed PDSCH transmission occasions within a single slot: and
Scheme 4 (TDM): two TRPs transmit PDSCH transmission occasions across K different slots alternatively.

In one embodiment, the UE needs to report the needed CSI information for the network using the CSI framework in NR Rel 15. The triggering mechanism between a report setting and a resource setting can be summarized in Table 2 below:

TABLE 2
Triggering mechanism between a report setting and a resource setting

| | | Periodic CSI | SP CSI | AP CSI |
|---|---|---|---|---|
| | | reporting | reporting | Reporting |
| Time Domain | Periodic | RRC | MAC CE (PUCCH) | DCI |
| Behavior of | CSI-RS | configured | DCI (PUSCH) | |
| Resource Setting | SP CSI-RS | Not Supported | MAC CE (PUCCH) | DCI |
| | | | DCI (PUSCH) | |
| | AP CSI-RS | Not Supported | Not Supported | DCI |

Moreover, in some embodiments,
All associated Resource Settings for a CSI Report Setting need to have same time domain behavior:
Periodic CSI-RS/IM resource and CSI reports are always assumed to be present and active once configured by RRC:
Aperiodic and semi-persistent CSI-RS/IM resources and CSI reports needs to be explicitly triggered or activated:
Aperiodic CSI-RS/IM resources and aperiodic CSI reports, the triggering is done jointly by transmitting a DCI Format 0-1: and
Semi-persistent CSI-RS/IM resources and semi-persistent CSI reports are independently activated.

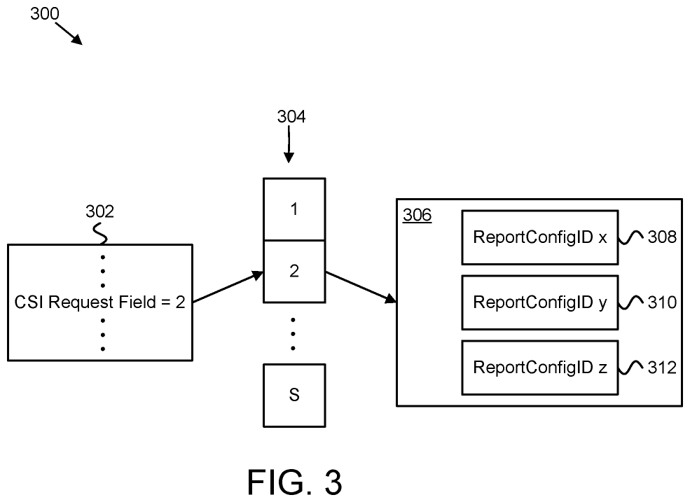

For multi-TRP URLLC, in one embodiment, aperiodic CSI reporting is likely to be triggered to inform the network about the channel conditions for every transmission hypothesis, since using periodic CSI-RS for the TRPs in the coordination cluster constitutes a large overhead. As mentioned earlier, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC, as shown in FIG. 3.

FIG. 3 is a diagram 300 illustrating one embodiment of an aperiodic trigger state defining a list of CSI report settings. Specifically, the diagram 300 includes a DCI format 0_1 302, a CSI request codepoint 304, and an aperiodic trigger state 2 306. Moreover, the aperiodic trigger state 2 includes a ReportConfigID x 308, a ReportConfigID y 310, and a ReportConfigID z 312. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

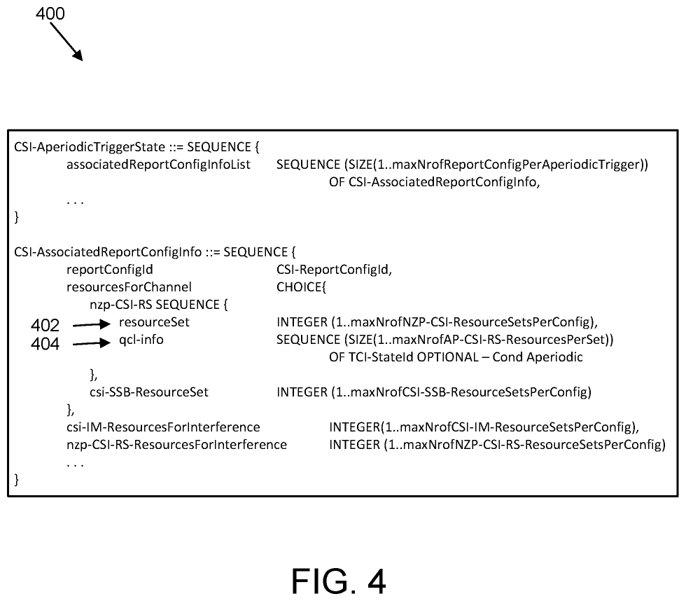

In one embodiment, if the CSI report setting is linked with aperiodic resource setting (e.g., may include multiple resource sets), the aperiodic NZP CSI-RS resource set for channel measurement, the aperiodic CSI-IM resource set (if used) and the aperiodic NZP CSI-RS resource set for interference management (“IM”) (if used) to use for a given CSI report setting are also included in the aperiodic trigger state definition, as shown in FIG. 4. For aperiodic NZP CSI-RS, QCL source may be configured in the aperiodic trigger state. The UE may assume that the resources used for the computation of the channel and interference can be processed with the same spatial filter e.g., quasi-co-located with respect to “QCL-TypeD.”

FIG. 4 is a code sample 400 illustrating one embodiment of the process by which an aperiodic trigger state indicates a resource set 402 and QCL information 404.

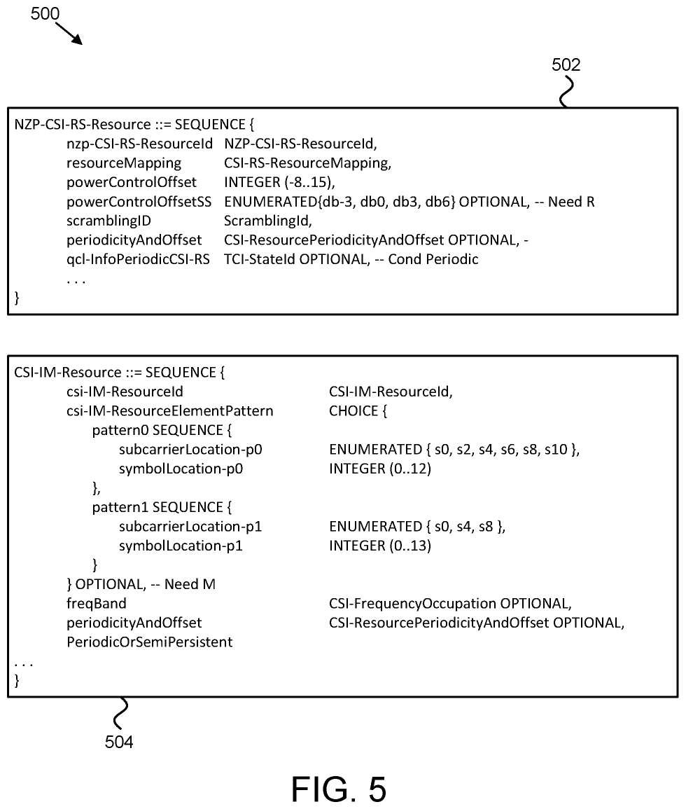

FIG. 5 is a code sample 500 illustrating one embodiment of an RRC configuration including a NZP-CSI-RS resource 502 and a CSI-IM-resource 504.

Table 3 shows the type of UL channels used for CSI reporting as a function of the CSI codebook type:

TABLE 3
UL channels used for CSI reporting as a function of the CSI codebook type

| | Periodic CSI reporting | SP CSI reporting | AP CSI reporting |
|---|---|---|---|
| Type I WB | PUCCH Format 2, 3, 4 | PUCCH Format 2 | PUSCH |
| | | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, in one embodiment, PUSCH-based reports are divided into two CSI parts: CSI Part 1 and CSI Part 2. The reason for this is that the size of CSI payload varies significantly, and therefore a worst-case UCI payload size design would result in large overhead.

In one embodiment, CSI Part 1 has a fixed payload size (and can be decoded by the gNB without prior information) and contains the following:
Rank indicator (“RI”) (if reported), CSI-RS resource indicator (“CRI”) (if reported), and channel quality indicator (“CQI”) for the first codeword,
number of non-zero wideband amplitude coefficients per layer for Type II CSI feedback on PUSCH.

In one embodiment, CSI Part 2 has a variable payload size that can be derived from the CSI parameters in CSI Part I and contains PMI and the CQI for the second codeword when RI>4.

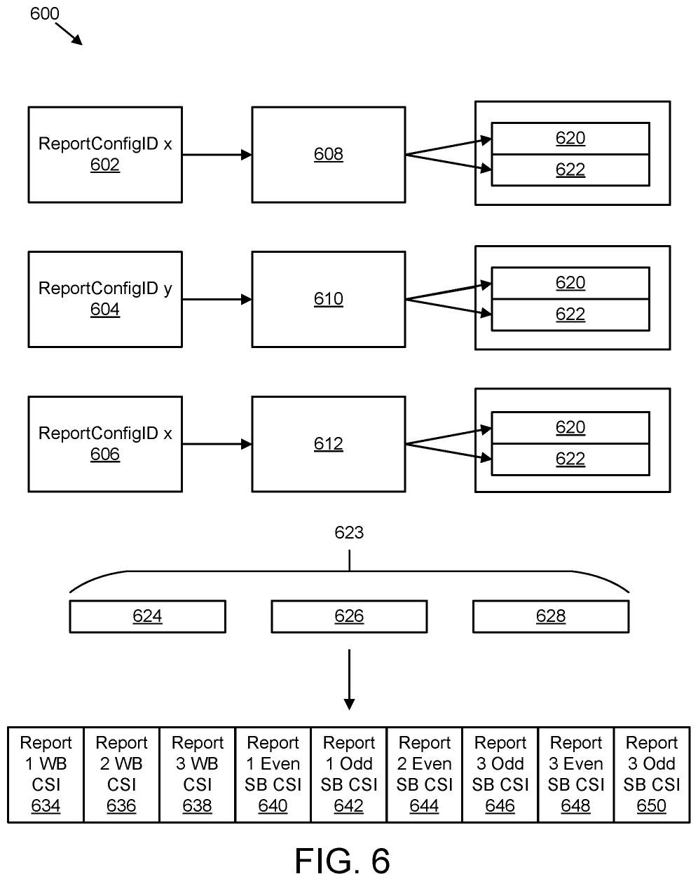

For example, if the aperiodic trigger state indicated by DCI format 0_1 defines 3 report settings x, y, and z, then the aperiodic CSI reporting for CSI part 2 will be ordered as indicated in FIG. 6.

FIG. 6 is a schematic block diagram 600 illustrating one embodiment of a partial CSI omission for PUSCH-based CSI. The diagram 600 includes a ReportConfigID x 602, a ReportConfigID y 604, and a ReportConfigID z 606. Moreover, the diagram 600 includes a first report 608 (e.g., requested quantities to be reported) corresponding to the ReportConfigID x 602, a second report 610 (e.g., requested quantities to be reported) corresponding to the ReportConfigID y 604, and a third report 612 (e.g., requested quantities to be reported) corresponding to the ReportConfigID z 606. Each of the first report 608, the second report 610, and the third report 612 includes a CSI part 1 620, and a CSI part 2 622. An ordering 623 of CSI part 2 across reports is CSI part 2 of the first report 624, CSI part 2 of the second report 626, and CSI part 2 of the third report 628. Moreover, the CSI part 2 reports may produce a report 1 WB CSI 634, a report 2 WB CSI 636, a report 3 WB CSI 638, a report 1 even SB CSI 640, a report 1 odd SB CSI 642, a report 2 even SB CSI 644, a report 2 odd SB CSI 646, a report 3 even SB CSI 648, and a report 3 odd SB CSI 650.

In various embodiments, CSI reports may be prioritized according to:
time-domain behavior and physical channel where more dynamic reports are given precedence over less dynamic reports and PUSCH has precedence over PUCCH:
CSI content where beam reports (e.g., L1-RSRP reporting) have priority over regular CSI reports:
a serving cell to which a CSI corresponds (e.g., for CA operation)—CSI corresponding to a PCell has priority over CSI corresponding to Scells; and/or
a report configuration identifier (e.g., reportConfigID).

In some embodiments, the ordering may not consider that some multi-TRP NCJT transmission hypothesis, as measured by the UE, may achieve low spectral efficiency performance and may be given a lower priority.

For UCI Bit Sequence Generation, the bitwidth for RI, layer indicator (“LI”), CQI, CRI of codebookType=type1-SinglePanel is provided in Table 4.

TABLE 4
RI, LI, CQI, and CRI of codebookType=typeI-SinglePanel

| | Bitwidth | | | | |
|---|---|---|---|---|---|
| | 1 antenna | 2 antenna | 4 antenna | >4 antenna ports | |
| Field | port | ports | ports | Rank1~4 | Rank5~8 |
| Rank Indicator | 0 | min (1, ┌log₂ n_{RI}┐) | min (2, ┌log₂ n_{RI}┐) | ┌log₂ n_{RI}┐ | ┌log₂ n_{RI}┐ |
| Layer Indicator | 0 | ┌log₂ ν┐ | min(2, ┌log₂ ν┐) | min(2, ┌log₂ ν┐) | min(2, ┌log₂ v┐) |
| Wide-band CQI for | 4 | 4 | 4 | 4 | 4 |
| the first TB | | | | | |
| Wideband CQI for | 0 | 0 | 0 | 0 | 4 |
| the second TB | | | | | |
| Subband differential | 2 | 2 | 2 | 2 | 2 |
| CQI for the first TB | | | | | |
| Subband differential | 0 | 0 | 0 | 0 | 2 |
| CQI for the second | | | | | |
| TB | | | | | |
| CRI | ┌log₂(Kₛ^{CSI-RS})┐ | ┌log₂(Kₛ^{CSI-RS})┐ | ┌log₂(Kₛ^{CSI-RS})┐ | ┌log₂(Kₛ^{CSI-RS})┐ | ┌log₂(Kₛ^{CSI-RS})┐ |

n_{RI} in Table 4 is the number of allowed rank indicator values according to Clause 5.2.2.2.1 Of TS 38.214. υ is the value of the rank. The value of Kₛ^{CSI-RS} is the number of CSI-RS resources in the corresponding resource set. The values of the rank indicator field are mapped to allowed rank indicator values with increasing order, where ‘0’ is mapped to the smallest allowed rank indicator value.

TABLE 5
Mapping order of CSI fields of one CSI report, pmi-FormatIndicator=widebandPMI
and cqi-FormatIndicator=widebandCQI

| CSI report | |
|---|---|
| number | CSI fields |
| CSI report #n | CRI as in Table 4, if reported |
| | Rank Indicator as in Table 4, if reported |
| | Layer Indicator as in Table 4, if reported |
| | Zero padding bits O_{P}, if needed |
| | PMI wideband information fields X₁, from left to right as in Tables |
| | 6.3.1.1.2-1/2 of TS38.214, if reported |
| | PMI wideband information fields X₂, from left to right as in Tables |
| | 6.3.1.1.2-1/2 of TS38.214, or codebook index for 2 antenna ports according |
| | to Clause 5.2.2.2.1 in TS38.214, if reported |
| | Wideband CQI for the first TB as in Table 4, if reported |
| | Wideband CQI for the second TB as in Table 4, if reported |

TABLE 6
Mapping order of CSI fields of one CSI report,
CSI part 1, pmi-FormatIndicator=subbandPMI
or cqi-FormatIndicator=subbandCQI

| CSI report | |
|---|---|
| number | CSI fields |
| CSI report #n | CRI as in Table 4, if reported |
| CSI part 1 | Rank Indicator as in Table 4, if reported |
| | Wideband CQI for the first TB as in Table 4, if reported |
| | Subband differential CQI for the first TB with increasing order of subband |
| | number as in Table 4, if reported |
| | Indicator of the number of non-zero wideband amplitude coefficients M₀ for |
| | layer 0 as in Table 6.3.1.1.2-5 of TS38.214, if reported |
| | Indicator of the number of non-zero wideband amplitude coefficients M₁ for |
| | layer 1 as in Table 6.3.1.1.2-5 of TS38.214 (if the rank according to the |
| | reported RI is equal to one, this field is set to all zeros), if 2-layer PMI |
| | reporting is allowed according to the rank restriction in Clauses 5.2.2.2.3 and |
| | 5.2.2.2.4 of TS 38.214 and if reported |

Note:
Subbands for given CSI report n indicated by the higher layer parameter csi-ReportingBand are numbered continuously in the increasing order with the lowest subband of csi-ReportingBand as subband 0.

TABLE 7
Mapping order of CSI fields of one CSI report, CSI part 2 wideband, pmi-FormatIndicator=
subbandPMI or cqi-FormatIndicator=subbandCQI

| CSI report | |
|---|---|
| number | CSI fields |
| CSI report #n | Wideband CQI for the second TB as in Table 4, if present and reported |
| CSI part 2 | Layer Indicator as in Table 4, if reported |
| wideband | PMI wideband information fields X₁, from left to right as in Tables |
| | 6.3.1.1.2-1/2 of TS38.214, if reported |
| | PMI wideband information fields X₂, from left to right as in Tables |
| | 6.3.1.1.2-1/2 of TS38.214, or codebook index for 2 antenna ports according |
| | to Clause 5.2.2.2.1 in TS38.214, if pmi-FormatIndicator= widebandPMI and |
| | if reported |

TABLE 8
Mapping order of CSI fields of one CSI report, CSI part 2 subband, pmi-FormatIndicator=
subbandPMI or cqi-FormatIndicator=subbandCQI

| | |
|---|---|
| CSI report | Subband differential CQI for the second TB of all even subbands with |
| #n | increasing order of subband number, as in Table 4, if cqi- |
| Part 2 | FormatIndicator=subbandCQI and if reported |
| subband | PMI subband information fields X₂ of all even subbands with increasing order |
| | of subband number, from left to right as in Tables 6.3.1.1.2-1/2 of TS38.214, or |
| | codebook index for 2 antenna ports according to Clause 5.2.2.2.1 in TS38.214 of |
| | all even subbands with increasing order of subband number, if pmi- |
| | FormatIndicator= subbandPMI and if reported |
| | Subband differential CQI for the second TB of all odd subbands with increasing |
| | order of subband number, as in Table 4, if cqi-FormatIndicator=subbandCQI |
| | and if reported |
| | PMI subband information fields X₂ of all odd subbands with increasing order |
| | of subband number, from left to right as in Tables 6.3.1.1.2-1/2 of TS38.214, or |
| | codebook index for 2 antenna ports according to Clause 5.2.2.2.1 in TS38.214 of |
| | all odd subbands with increasing order of subband number, if pmi- |
| | FormatIndicator= subbandPMI and if reported |

Note: Subbands for given CSI report n indicated by the higher layer parameter csi-ReportingBand are numbered continuously in the increasing order with the lowest subband of csi-ReportingBand as subband 0).

TABLE 9
Mapping order of CSI fields of one CSI report, CSI part 2 of codebookType = typeII-r16
or typeII-PortSelection-r16

| CSI report | CSI fields |
|---|---|
| number | |
| CSI report #n | PMI fields X₁, from left to right as in Tables 6.3.2.1.2-1A/2A of TS38.214, if |
| CSI part 2, | reported |
| group 0 | |
| CSI report #n CSI part 2, group 1 | The following PMI fields X₂, from left to right, as in Tables 6.3.2.1.2-1A/2A $of TS 38.214 : \{ {i}_{2 , 4 , l} : l = 1 , … , υ \} , {i}_{1 , 5} , \{ {i}_{1 , 6 , l} : l = 1 , … , υ \} and ( ⌈ \frac{{K}^{NZ}}{2} ⌉ - υ ) \times 3$ |
| | highest priority bits of |
| | {i_{2,4,l}: l = 1, ... , υ}, (┌K^{NZ}/2┐ − υ) × 4 highest priority bits of {i_{2,5,1}: l = |
| | 1, ... , υ} and v * 2LM_{υ} − [K^{NZ}/2] highest priority bits of{[i_{1,7,1}: l = 1, ... , υ}, |
| | in decreasing order of priority based on function Pri(l, i, f) defined in clause |
| | 5.2.3 of TS38.214, if reported |
| CSI report #n | The following PMI fields X₂, from left to right, as in Tables 6.3.2.1.2-1A/2A |
| CSI part 2, | of TS38.214: [K^{NZ}/2] × 3 lowest priority bits of {i_{2,4,1}: l = 1, ... , 0}, [K^{NZ}/ |
| group 2 | 2] × 4 lowest priority bits of {i_{2,5,1}: l = 1, ... , υ} and [K^{NZ}/2] lowest priority |
| | bits of {i_{1,7,1}: l = 1, ... , υ], in decreasing order of priority based on function |
| | Pri(l, i, f) defined in clause 5.2.3 of TS38.214, if reported |

The CSI report content in UCI, whether on PUCCH or PUSCH, is provided in detail in 3GPP TS 38.212. The Rank Indicator (RI), if reported, has bitwidth of min(┌log₂ Nₚₒᵣₜₛ ┐, ┌log₂ n_{RI}┐), where Nₚₒᵣₜₛ, n_{RI} represent the number of antenna ports and the number of allowed rank indicator values, respectively. On the other hand, the CSI-RS Resource Indicator (CRI) and the Synchronization Signal Block Resource Indicator (SSBRI) each have bitwidths of ┌log₂ Kₛ^{CSI-RS}┐, ┌log₂ Kₛ^{SSB}┐, respectively, where Kₛ^{CSI-RS} is the number of CSI-RS resources in the corresponding resource set, and Kₛ^{SSB} is the configured number of SS/PBCH blocks in the corresponding resource set for reporting ‘ssb-Index-RSRP’. The mapping order of CSI fields of one CSI report with wideband PMI and wideband CQI on PUCCH is depicted in Table 10 is as follows.

TABLE 10
Mapping order of CSI fields of one CSI report
with wideband PMI and CQI on PUCCH

| CSI report | |
|---|---|
| number | CSI fields |
| CSI report #n | CRI, if reported |
| | Rank Indicator, if reported |
| | Layer Indicator, if reported |
| | Zero padding bits, if needed |
| | PMI wideband information fields, if reported |
| | PMI wideband information, if reported |
| | Wideband CQI for the first Transport Block, if reported |
| | Wideband CQI for the second Transport Block, if |
| | reported |

Several embodiments are described below. According to a possible embodiment, one or more elements or features from one or more of the described embodiments may be combined, e.g., for CSI measurement, feedback generation and/or reporting which may reduce the overall CSI feedback overhead.

Initially, a set of preliminary assumptions for the problem may include:
“TRP” notion in used in a general fashion to include e.g., at least one of TRPs, cells, nodes, panels, communication (e.g., signals/channels) associated with a control resource set (“CORESET”) (control resource set) pool, communication associated with a transmission configuration indicator (“TCI”) state from a transmission configuration comprising at least two TCI states.
The codebook type used is arbitrary; flexibility for use different codebook types (Type-I and Type-II codebooks), unless otherwise stated.
A UE is triggered with two or more DCI, wherein the multi-TRP scheme may be based on one of SDM (scheme 1a), FDM (schemes 2a/2b), and TDM (schemes 3/4), as specified in 3GPP TS 38.214. Other transmission schemes are not precluded.

In one embodiment directed to CSI Reporting Configuration and Feedback for multi-TRP, a UE is configured by higher layers with one or more CSI-ReportConfig Reporting Settings for CSI reporting, one or more CSI-ResourceConfig Resource Settings for CSI measurement, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList may contain a list of a subset of the associated CSI-ReportConfigs indicating the Resource Set IDs for channel and optionally for interference. Each trigger state in CSI-SemiPersistentOnPUSCH-TriggerStateList may contain one or more associated CSI-ReportConfig. Different embodiments for indication of multi-TRP transmission are provided below. Considering a setup with a combination of one or more of the following embodiments is not precluded.

Different embodiments for indication of multi-TRP transmission are provided below. Considering a setup with a combination of one or more of the following embodiments is not precluded.

In a first embodiment, a UE configured with multi-TRP transmission may receive two PDCCHs wherein CORESETs ControlResourceSets corresponding to the two PDCCHs may have different values of CORESETPoolIndex CORESET Pool Index. Each PDCCH may schedule a PDSCH, or alternatively both PDCCHs can schedule one PDSCH, e.g., same or repetition of PDSCH scheduling assignment in each of the PDCCH.

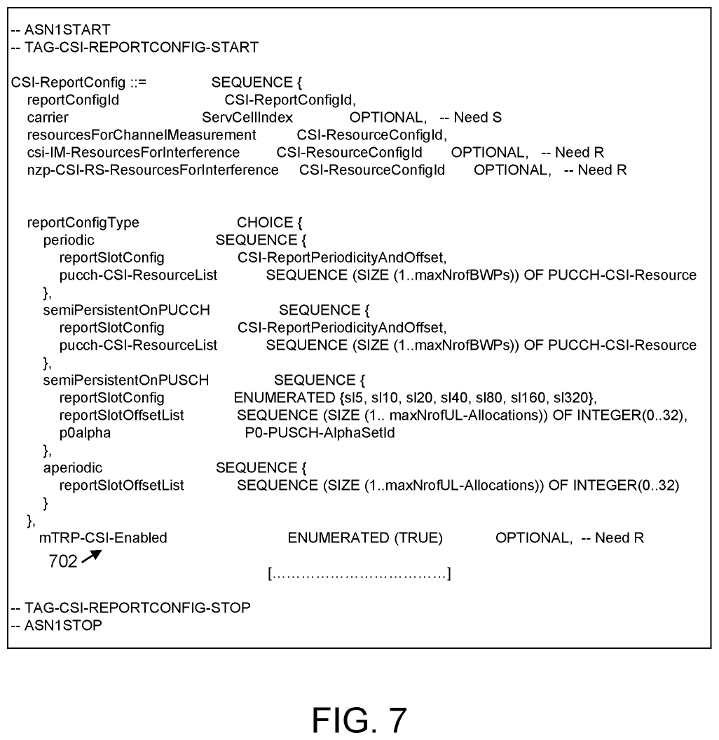

In a second embodiment, a UE configured with multi-TRP transmission may be configured with one or more CSI Reporting Settings CSI-ReportConfig, wherein at least one of the one or more CSI Reporting Settings CSI-ReportConfig includes a higher-layer parameter, e.g., mTRP-CSI-Enabled, that configures the UE with multi-TRP transmission, e.g., NCJT. An example of the ASN.1 code that corresponds to such CSI-ReportConfig Reporting Setting IE is provided in FIG. 7, with a higher-layer parameter that triggers multi-TRP based CSI reporting 702. The ASN.1 code for the Rel. 16 Report Setting can be found in FIG. 7 (e.g., as specified in 3GPP TS 38.331).

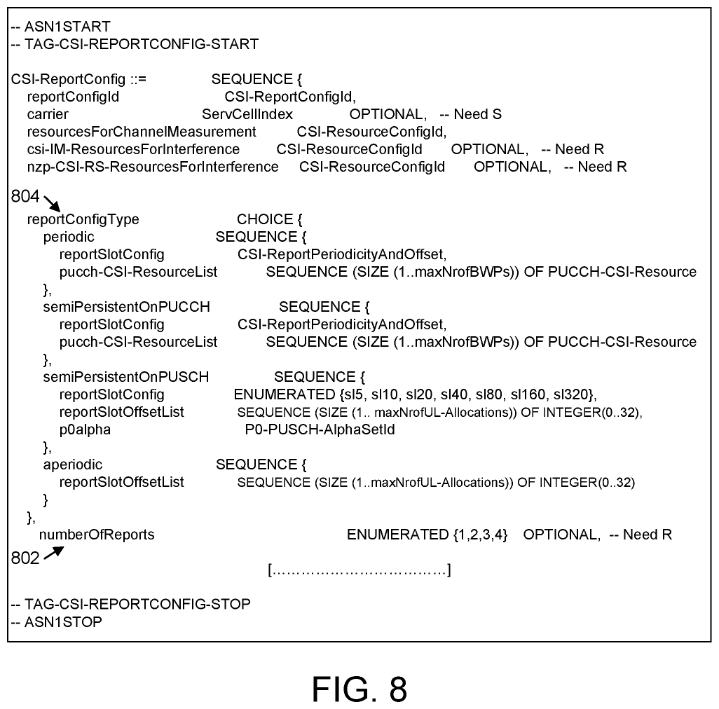

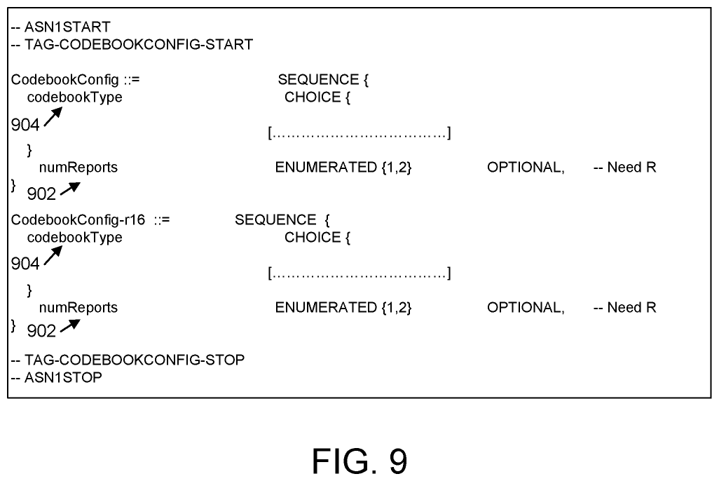

In a third embodiment, a UE configured with multi-TRP transmission may be configured with one or more CSI Reporting Settings CSI-ReportConfig, wherein at least one of the one or more CSI Reporting Settings CSI-ReportConfig includes a higher-layer parameter which triggers the UE to report a given number of CSI Reports, e.g., numberOfReports, in the CSI-ReportConfig Reporting Setting or any of its elements, e.g., codebookConfig. Examples of the ASN.1 code the correspond to the CSI-ReportConfig Reporting Setting IE are provided in FIGS. 8 and 9, where the number of CSI Reports 802, 902 is triggered within the Reporting Setting 804 or the codebook configuration 904, respectively.

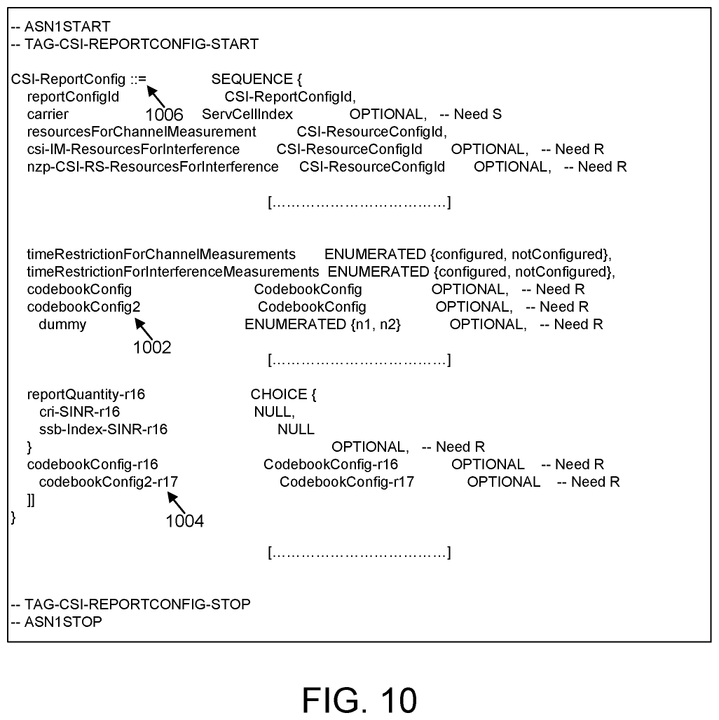

In a fourth embodiment, a UE configured with multi-TRP transmission may be configured with one or more CSI Reporting Settings CSI-ReportConfig, wherein at least one of the one or more CSI Reporting Settings CSI-ReportConfig configures two CodebookConfig codebook configurations corresponding to one or more CSI Reports. An example of the ASN.1 code the corresponds to the CSI-ReportConfig Reporting Setting IE is provided in FIG. 10, wherein two codebook configurations 1002, 1004 are triggered under the same Reporting Setting 1006.

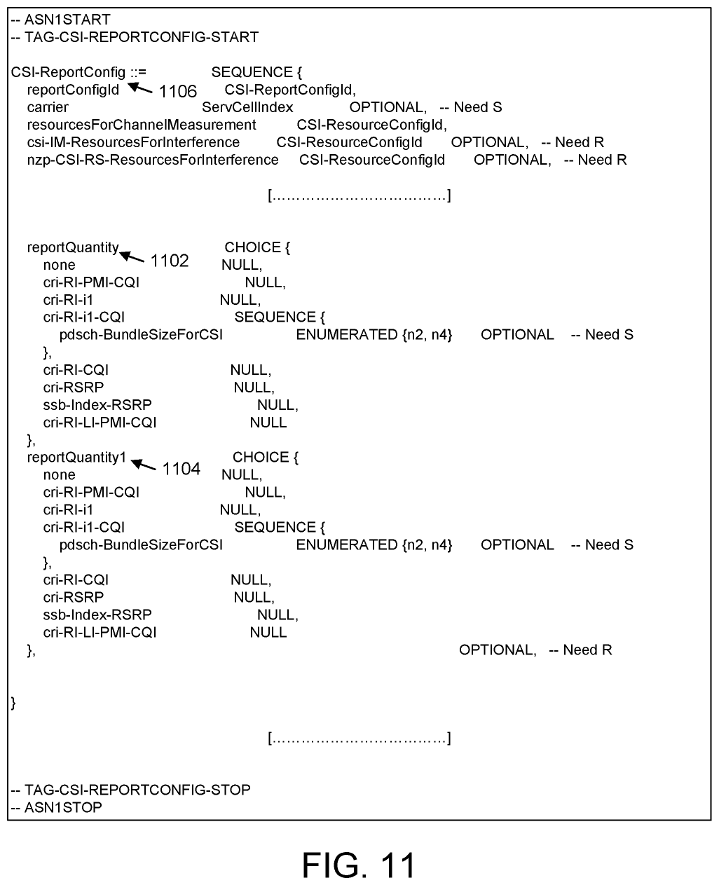

In a fifth embodiment, a UE configured with multi-TRP transmission may be configured with one or more CSI Reporting Settings CSI-ReportConfig, wherein at least one of the one or more CSI Reporting Settings CSI-ReportConfig configures two reportQuantity Report Quantities 1102, 1104 corresponding to one or more CSI Reports. An example of the ASN.1 code the corresponds to the CSI-ReportConfig 1106 Reporting Setting IE is provided in FIG. 11.

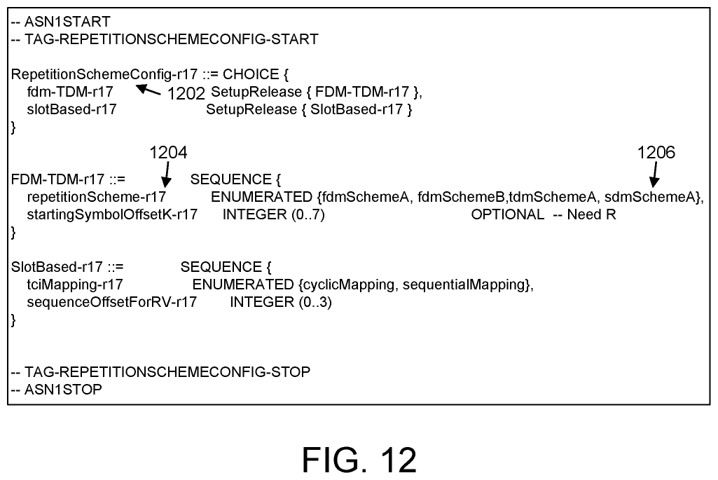

In a sixth embodiment, a UE configured with multi-TRP transmission may be configured with an IE for Repetition Scheme Configuration, e.g., RepetitionSchemeConfig-r17 1202 in at least one PDSCH configuration PDSCH-Config, wherein the Repetition Scheme Configuration contains a higher-layer parameter for a Repetition Scheme 1204, e.g., repetitionScheme-r17, that is set to a value that corresponds to multi-TRP transmission with overlapping time/frequency resources, e.g., the parameter repetitionScheme-r17 is set to ‘sdmSchemeA’ 1206. An example of the ASN.1 code that corresponds to the RepetitionSchemeConfig Repetition Scheme Configuration IE is provided in FIG. 12.

In a seventh embodiment, a UE configured with multi-TRP transmission may be indicated with two TCI states in a codepoint of the DCI field ‘Transmission Configuration Indication’ and demodulation reference signal (“DMRS”) port(s) within two code division multiplexing (CDM) groups in the DCI field “Antenna Port(s)”.

In some of the examples, a single-DCI based multi-TRP transmission may correspond to a transmission scheme comprising a PDSCH codeword transmitted from more than one TRP, e.g., the PDSCH codeword is associated to more than one TCI states. In some of the examples, a multi-DCI based multi-TRP transmission may correspond to a transmission scheme comprising a first PDSCH codeword transmitted from a first TRP, e.g., the first PDSCH codeword associated with a first TCI state, and a second PDSCH codeword transmitted from a second TRP (e.g., the second PDSCH codeword associated with a first TCI state.

In one embodiment directed to UCI bit sequence generation for CSI reports under multi-TRP CSI framework, a UE may be configured with a CSI Reporting Setting CSI-ReportConfig that triggers CSI reporting for one or more transmission hypotheses, e.g., single-TRP transmission hypothesis and NCJT hypothesis. In one example, a single-TRP transmission hypothesis corresponds to CSI reporting based on a single NZP CSI-RS resource for channel measurement, e.g., channel measurement resources (“CMRs”). In another example, an NCJT hypothesis corresponds to CSI reporting based on an NZP CSI-RS resource pair for channel measurement, i.e., CMR pair. Different embodiments for CSI report content are provided below. Considering a setup with a combination of one or more of the following embodiments is not precluded.

In a first embodiment, CSI corresponding to one or more transmission hypotheses can be reported within a single CSI report, wherein a CSI report includes one of the following:
CSI corresponding to one non-coherent joint transmission (“NCJT”) hypothesis:
CSI corresponding to one NCJT hypothesis and one single-TRP transmission hypothesis:
CSI corresponding to one NCJT hypothesis and two single-TRP transmission hypotheses: and/or
CSI corresponding to a best one transmission hypothesis from a set of one NCJT hypothesis and one or more single-TRP transmission hypotheses:

In a second embodiment, a Part 1 of the CSI report includes Rank Indicators corresponding to all transmission hypotheses.

In a third embodiment, a Part 1 of the CSI report includes CRI values corresponding to all transmission hypotheses.

In a fourth embodiment, CQI corresponding to one transport block (“TB”) of one transmission hypothesis from the set of NCJT and single-TRP hypotheses is reported in CSI Part 1. In one example, CQI corresponding to TB for NCJT hypothesis is included in CSI Part 1, whereas CQI corresponding to one or more TBs for one or more single-TRP transmission hypotheses is included in a subsequent part of the CSI report, e.g., CSI Part 2.

In a fifth embodiment, one or more PMI values corresponding to NCJT hypotheses are mapped to CSI fields that precede one or more PMI values corresponding to single-TRP hypotheses.

In a sixth embodiment, one or more PMI values corresponding to NCJT hypothesis are mapped to CSI fields that precede one or more CQI values corresponding to one or more single-TRP transmission hypotheses.

In a seventh embodiment, one or more PMI values corresponding to single-TRP hypotheses are mapped to CSI fields that precede one or more CQI values corresponding to the same one or more single-TRP transmission hypotheses.

In a eighth embodiment, a Rank Indicator corresponding to a single-TRP hypothesis transmission cannot take on a value larger than four. In one example, the rank restriction is set by a rule, wherein a CSI report configuration that configures multi-TRP CSI reporting restricts the rank indicator value by four by default for all hypotheses.

In a ninth embodiment, a UE can be configured with reporting at least two CQI values for different hypotheses, wherein the CQI format of the at least two CQI values is not the same, e.g., a first of the at least two CQI values is reported in ‘sub-band’ format and a second of the at least two CQI values is reported in ‘wideband’ format. In a first example, two or more CQI format indicators are configured within one CSI Report Config. In a second example, one CQI format indicator is reported, wherein CQI values subsequent to the first CQI value are reported in ‘wideband’ format by default.

In a tenth embodiment, wideband CQI for the first TB under a first single TRP hypothesis is conditioned/based on the first CRI, first RI, first LI, first PMI; and wideband CQI for the first TB under a second single TRP hypothesis is conditioned/based on the second CRI, second RI, second LI, second PMI.

In the tables below, “NCJT” may mean CSI computed under NCJT hypothesis (e.g., CSI computed based on at least two CSI resources for channel measurement, the at least two CSI resources may be associated with at least two TRPs (e.g., first TRP and second TRP)); “single TRP” may mean CSI computed under single-TRP hypothesis (e.g., CSI computed based on one CSI resource for channel measurement, the one CSI resource may be associated with a single TRP (e.g., first TRP or second TRP)).

One example of a mapping order of CSI fields of one CSI report with pmi-FormatIndicator=‘widebandPMI’ and cqi-FormatIndicator=‘widebandCQI’ is provided in Table 11, for Case (iii) of CSI reporting according to the first embodiment described above.

TABLE 11
An example of a mapping order of CSI fields of
one CSI report, pmi-FormatIndicator=widebandPMI
and cqi-FormatIndicator=widebandCQI

| CSI report | |
|---|---|
| number | CSI fields |
| CSI report #n | Two CRIs for NCJT, if reported. CRIs may be mapped to one codepoint |
| | Two Rank Indicators for NCJT, if reported. Rank Indicators may be mapped |
| | to one codepoint |
| | Two Layer Indicators for NCJT, if reported |
| | CRI under first single-TRP, if reported |
| | Rank Indicator under first single-TRP, if reported |
| | Layer Indicator under first single-TRP, if reported |
| | CRI under second single-TRP, if reported |
| | Rank Indicator under second single-TRP, if reported |
| | Layer Indicator under second single-TRP, if reported |
| | Zero padding bits, if needed |
| | PMI wideband information fields X₁ of first PMI for NCJT, if reported |
| | PMI wideband information fields X₁ of second PMI for NCJT, if reported |
| | PMI wideband information fields X₂ of first PMI for NCJT, if reported |
| | PMI wideband information fields X₂ of second PMI for NCJT, if reported |
| | Wideband CQI for the TB under NCJT, if reported |
| | Wideband CQI for the first TB under first single TRP, if reported |
| | Wideband CQI for the second TB under first single TRP, if reported |
| | PMI wideband information fields X₁ for first single TRP, if reported |
| | PMI wideband information fields X₂ for first single TRP, if reported |
| | Wideband CQI for the first TB under second single TRP, if reported |
| | Wideband CQI for the second TB under second single TRP, if reported |
| | PMI wideband information fields X₁ for second single TRP, if reported |
| | PMI wideband information fields X₂ for second single TRP, if reported |

One example of a mapping order of CSI fields of Part I of a CSI report with pmi-FormatIndicator ‘subbandPMI’ or cqi-FormatIndicator ‘subbandCQI’ is provided in Table 12Error! Reference source not found. for Case (iii) of CSI reporting according to the first embodiment described above.

TABLE 12
An example of a mapping order of CSI fields of one CSI report, CSI part 1, pmi-
FormatIndicator= subbandPMI or cqi-FormatIndicator=subbandCQI

| CSI report | |
|---|---|
| number | CSI fields |
| CSI report #n | First CRI for NCJT, if reported |
| CSI part 1 | Second CRI for NCJT, if reported |
| | Rank Indicator for NCJT, if reported |
| | Wideband CQI for NCJT TB, if reported |
| | Subband differential CQI for NCJT TB with increasing order of subband |
| | number, if reported |
| | CRI for first single-TRP, if reported |
| | CRI for second single-TRP, if reported |
| | Rank Indicator for first single-TRP, if reported |
| | Rank Indicator for second single-TRP, if reported |

Note:
Subbands for given CSI report n indicated by the higher layer parameter csi-ReportingBand are numbered continuously in the increasing order with the lowest subband of csi-ReportingBand as subband 0.

In some examples, the wideband CQI (in some cases, and Subband differential CQI) for the first TB for first and/or second single-TRP, if present and reported, is included in CSI part 1.

One example of a mapping order of CSI fields of Part 2 of a CSI report for wideband parameters with pmi-FormatIndicator=‘subbandPMI’ or cqi-FormatIndicator=‘subbandCQI’ is provided in Table 13, for Case (iii) of CSI reporting according to the first embodiment described above.

TABLE 13
An example of a mapping order of CSI fields of one CSI report, CSI part 2
wideband, pmi-FormatIndicator= subbandPMI or cqi-FormatIndicator=subbandCQI

| CSI report | |
|---|---|
| number | CSI fields |
| CSI report #n | First layer Indicator for NCJT, if reported |
| Part 2 | Second layer Indicator for NCJT, if reported |
| wideband | First PMI wideband information fields X₁ for NCJT, if reported |
| | First PMI wideband information fields X₂ for NCJT, if pmi- |
| | FormatIndicator= widebandPMI and if reported |
| | Second PMI wideband information fields X₁ for NCJT, if reported |
| | Second PMI wideband information fields X₂ for NCJT, if pmi- |
| | FormatIndicator= widebandPMI and if reported |
| | Wideband CQI for the first TB for first single-TRP, if present and reported |
| | Wideband CQI for the second TB for first single-TRP, if present and reported |
| | Layer Indicator for first single-TRP, if reported |
| | PMI wideband information fields X₁ for first single-TRP, if reported |
| | PMI wideband information fields X₂ for first single-TRP, if pmi- |
| | FormatIndicator= widebandPMI and if reported |
| | Wideband CQI for the first TB for second single-TRP, if present and reported |
| | Wideband CQI for the second TB for second single-TRP, if present and |
| | reported |
| | Layer Indicator for second single-TRP, if reported |
| | PMI wideband information fields X₁ for second single-TRP, if reported |
| | PMI wideband information fields X₂ for second single-TRP, if pmi- |
| | FormatIndicator= widebandPMI and if reported |

A first example of a mapping order of CSI fields of Part 2 of a CSI report for subband parameters with pmi-FormatIndicator subbandPMI′ or cqi-FormatIndicator ‘subbandCQI’ is provided Table 14, for Case (iii) of CSI reporting according to the first embodiment described above.

TABLE 14
Example 1 of a mapping order of CSI fields of one CSI report, CSI part 2
subband, pmi-FormatIndicator= subbandPMI or cqi-FormatIndicator=subbandCQI

| | |
|---|---|
| CSI report | First PMI sub-band information fields X₂ for NCJT of all even subbands with |
| #n | increasing order of subband number, if pmi-FormatIndicator= subbandPMI and |
| Part 2 | if reported |
| subband | Second PMI sub-band information fields X₂ for NCJT of all even subbands |
| | with increasing order of subband number, if pmi-FormatIndicator= |
| | subbandPMI and if reported |
| | Subband differential CQI for the first TB for first single-TRP of all even |
| | subbands with increasing order of subband number, if cqi- |
| | FormatIndicator=subbandCQI and if reported |
| | PMI sub-band information fields X₂ for first single-TRP of all even subbands |
| | with increasing order of subband number, if pmi-FormatIndicator= |
| | subbandPMI and if reported |
| | Subband differential CQI for the first TB for second single-TRP of all even |
| | subbands with increasing order of subband number, if cqi- |
| | FormatIndicator=subbandCQI and if reported |
| | PMI sub-band information fields X₂ for second single-TRP of all even |
| | subbands with increasing order of subband number, if pmi-FormatIndicator= |
| | subbandPMI and if reported |
| | First PMI sub-band information fields X₂ for NCJT of all odd subbands with |
| | increasing order of subband number, if pmi-FormatIndicator= subbandPMI and |
| | if reported |
| | Second PMI sub-band information fields X₂ for NCJT of all odd subbands with |
| | increasing order of subband number, if pmi-FormatIndicator= subbandPMI and |
| | if reported |
| | Subband differential CQI for the first TB for first single-TRP of all odd |
| | subbands with increasing order of subband number, if cqi- |
| | FormatIndicator=subbandCQI and if reported |
| | PMI sub-band information fields X₂ for first single-TRP of all odd subbands |
| | with increasing order of subband number, if pmi-FormatIndicator= |
| | subbandPMI and if reported |
| | Subband differential CQI for the first TB for second single-TRP of all odd |
| | subbands with increasing order of subband number, if cqi- |
| | FormatIndicator=subbandCQI and if reported |
| | PMI sub-band information fields X₂ for second single-TRP of all odd subbands |
| | with increasing order of subband number, if pmi-FormatIndicator= |
| | subbandPMI and if reported |
| | Subband differential CQI for the second TB for first single-TRP of all even |
| | subbands with increasing order of subband number, if cqi- |
| | FormatIndicator=subbandCQI and if reported |
| | Subband differential CQI for the second TB for second single-TRP of all even |
| | subbands with increasing order of subband number, if cqi- |
| | FormatIndicator=subbandCQI and if reported |
| | Subband differential CQI for the second TB for first single-TRP of all odd sub- |
| | bands with increasing order of subband number, if cqi- |
| | FormatIndicator=subbandCQI and if reported |
| | Subband differential CQI for the second TB for second single-TRP of all odd |
| | sub-bands with increasing order of subband number, if cqi- |
| | FormatIndicator=subbandCQI and if reported |

Note:
Subbands for given CSI report n indicated by the higher layer parameter csi-ReportingBand are numbered continuously in the increasing order with the lowest subband of csi-ReportingBand as subband 0.

A second example of a mapping order of CSI fields of Part 2 of a CSI report for subband parameters with pmi-formatIndicator=‘subbandPMI’ or cqi-FormatIndicator=‘subbandCQI’ is provided in Table 15, for Case (iii) of CSI reporting according to the first embodiment described above.

TABLE 15
Example 2 of a mapping order of CSI fields of one CSI report, CSI part 2
subband, pmi-FormatIndicator= subbandPMI or cqi-FormatIndicator=subbandCQI

| | |
|---|---|
| CSI report | First PMI subband information fields X₂ for NCJT of all even subbands with |
| #n | increasing order of subband number, if pmi-FormatIndicator= subbandPMI and |
| Part 2 | if reported |
| subband | Second PMI subband information fields X₂ for NCJT of all even subbands with |
| | increasing order of subband number, if pmi-FormatIndicator= subbandPMI and |
| | if reported |
| | Subband differential CQI for the first TB for first single-TRP of all even |
| | subbands with increasing order of subband number, if cqi- |
| | FormatIndicator=subbandCQI and if reported |
| | Subband differential CQI for the second TB for first single-TRP of all even |
| | subbands with increasing order of subband number, if cqi- |
| | FormatIndicator=subbandCQI and if reported |
| | PMI subband information fields X₂ for first single-TRP of all even subbands |
| | with increasing order of subband number, if pmi-FormatIndicator= |
| | subbandPMI and if reported |
| | Subband differential CQI for the first TB for second single-TRP of all even |
| | subbands with increasing order of subband number, if cqi- |
| | FormatIndicator=subbandCQI and if reported |
| | Subband differential CQI for the second TB for second single-TRP of all even |
| | subbands with increasing order of subband number, if cqi- |
| | FormatIndicator=subbandCQI and if reported |
| | PMI subband information fields X₂ for second single-TRP of all even subbands |
| | with increasing order of subband number, if pmi-FormatIndicator= |
| | subbandPMI and if reported |
| | First PMI subband information fields X₂ for NCJT of all odd subbands with |
| | increasing order of subband number, if pmi-FormatIndicator= subbandPMI and |
| | if reported |
| | Second PMI subband information fields X₂ for NCJT of all odd subbands with |
| | increasing order of subband number, if pmi-FormatIndicator= subbandPMI and |
| | if reported |
| | Subband differential CQI for the first TB for first single-TRP of all odd |
| | subbands with increasing order of subband number, if cqi- |
| | FormatIndicator=subbandCQI and if reported |
| | Subband differential CQI for the second TB for first single-TRP of all odd |
| | subbands with increasing order of subband number, if cqi- |
| | FormatIndicator=subbandCQI and if reported |
| | PMI subband information fields X₂ for first single-TRP of all odd subbands |
| | with increasing order of subband number, if pmi-FormatIndicator= |
| | subbandPMI and if reported |
| | Subband differential CQI for the first TB for second single-TRP of all odd |
| | subbands with increasing order of subband number, if cqi- |
| | FormatIndicator=subbandCQI and if reported |
| | Subband differential CQI for the second TB for second single-TRP of all odd |
| | subbands with increasing order of subband number, if cqi- |
| | FormatIndicator=subbandCQI and if reported |
| | PMI subband information fields X₂ for second single-TRP of all odd subbands |
| | with increasing order of subband number, if pmi-FormatIndicator= |
| | subbandPMI and if reported |

In an eleventh embodiment, a UE method includes:
receiving a first CSI report configuration comprising a first CSI hypothesis (NCJT, multi-TRP CSI) based on at least two CSI resources for channel measurement, and a second CSI hypothesis (single-TRP) based on only one CSI resource for channel measurement:
receiving a second CSI report configuration comprising a third CSI hypothesis based on at least two CSI resources for channel measurement, and a fourth CSI hypothesis based on only one CSI resource for channel measurement;
assigning a first priority level to wideband CSI associated with the first CSI hypothesis and wideband CSI associated with the third CSI hypothesis and a second priority level to wideband CSI associated with the second CSI hypothesis and wideband CSI associated with the fourth CSI hypothesis, wherein the first priority level has higher priority than the second priority level:
transmitting CSI comprising at least wideband CSI associated to the first CSI report and the second CSI report according to the assigned priority level in increasing order of priority level (ordered from the highest priority to the lowest priority) on an UL resource.

In one example, the method includes the UE:
determining a first priority value associated with the first CSI report, and a second priority value associated with the second CSI report, wherein the first priority value has higher priority than the second priority value: and
ordering the wideband CSI for a priority level in increasing order of CSI report priority values. In another example, the UE assigning a third priority level to subband CSI associated with the first CSI hypothesis and a fourth priority level to subband CSI associated with the third CSI hypothesis wherein the third priority level and the fourth priority level has higher priority than the second priority level.

In yet another example, the method includes the UE assigning a third priority level to subband CSI associated with the second CSI hypothesis and a fourth priority level to subband CSI associated with the fourth CSI hypothesis wherein the third priority level and the fourth priority level have lower priority than the second priority level.

In one embodiment directed to UL resources carrying CSI reports under multi-TRP CSI framework, a UE may be configured with a CSI Reporting Setting CSI-ReportConfig that triggers CSI reporting for one or more transmission hypotheses, e.g., single-TRP transmission hypothesis and NCJT hypothesis. In one example, a single-TRP transmission hypothesis corresponds to CSI reporting based on a single NZP CSI-RS resource for channel measurement, e.g., CMR. In another example, an NCJT hypothesis corresponds to CSI reporting based on an NZP CSI-RS resource pair for channel measurement, e.g., CMR pair. Each transmission hypothesis may correspond to a different CSI report. Different embodiments that address CSI report collision are provided below. Considering a setup with a combination of one or more of the following embodiments is not precluded.

In a first embodiment, two CSI reports are said to collide if the time occupancy of the physical channels scheduled to carry the CSI reports overlap in at least one orthogonal frequency-division multiplexing (“OFDM”) symbol and are transmitted on the same carrier. If the two CSI reports are carried over the same PUCCH (or PUSCH) resource, no collision is assumed.

In a second embodiment, two CSI reports are said to collide if the time occupancy of the physical channels scheduled to carry the CSI reports overlap in at least one OFDM symbol and are transmitted on the same carrier. If the two CSI reports are configured with the same CSI reporting setting, no collision is assumed.

In a third embodiment, two CSI reports configured with different CSI Reporting Settings (different CSI-ReportConfigId) are said to collide if the time occupancy of the physical channels scheduled to carry the CSI reports overlap in at least one OFDM symbol and are transmitted on the same carrier.

In a fourth embodiment, CSI reports configured with a same CSI Reporting Setting are mapped to different CSI fields in UCI that are carried on at least one of the same PUSCH resource or the same PUCCH resource.

In some embodiments, the terms antenna, panel, and antenna panel are used interchangeably herein. An antenna panel may be a hardware that is used for transmitting and/or receiving radio signals at frequencies lower than 6 GHz, e.g., FR1, or higher than 6 GHz, e.g., FR2 or mmWave. In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel: with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

- ‘QCL-TypeA’: {Doppler shift, Doppler spread, average delay,
delay spread}
- ‘QCL-TypeB’: {Doppler shift, Doppler spread}
- ‘QCL-TypeC’: {Doppler shift, average delay}
- ‘QCL-TypeD’: {Spatial Rx parameter}.

Spatial Rx parameters may include one or more of: angle of arrival (“AoA”) Dominant AoA, average AoA, angular spread, Power Angular Spectrum (“PAS”) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, i.e. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same RX beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (“CDD”). The procedure used to derive antenna ports from physical antennas may be specific to a device implementation and transparent to other devices.

In some of the embodiments described, a Transmission Configuration Indication (“TCI”)-state associated with a target transmission can indicate parameters for configuring a quasi-collocation relationship between the target transmission (e.g., target RS of DM-RS ports of the target transmission during a transmission occasion) and a source reference signal(s) (e.g., an SSB, a CSI-RS, a sounding reference signal (“SRS”), etc.) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the embodiments described, a TCI state comprises at least one source RS to provide a reference (UE assumption) for determining QCL and/or spatial filter.

In some of the embodiments described, a spatial relation information associated with a target transmission can indicate parameters for configuring a spatial setting between the target transmission and a reference RS (e.g., an SSB, a CSI-RS, an SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

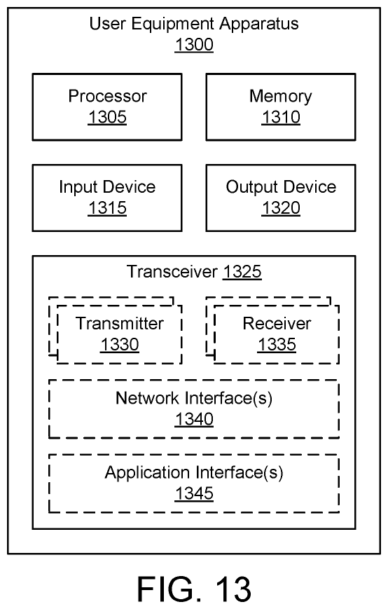

FIG. 13 depicts a user equipment apparatus 1300 that may be used for CSI reporting for multiple transmit/receive points and frequency division duplex reciprocity, according to embodiments of the disclosure. In various embodiments, the user equipment apparatus 1300 is used to implement one or more of the solutions described above. The user equipment apparatus 1300 may be one embodiment of the remote unit 105 and/or the UE 205, described above. Furthermore, the user equipment apparatus 1300 may include a processor 1305, a memory 1310, an input device 1315, an output device 1320, and a transceiver 1325.

In some embodiments, the input device 1315 and the output device 1320 are combined into a single device, such as a touchscreen. In certain embodiments, the user equipment apparatus 1300 may not include any input device 1315 and/or output device 1320. In various embodiments, the user equipment apparatus 1300 may include one or more of: the processor 1305, the memory 1310, and the transceiver 1325, and may not include the input device 1315 and/or the output device 1320.

As depicted, the transceiver 1325 includes at least one transmitter 1330 and at least one receiver 1335. In some embodiments, the transceiver 1325 communicates with one or more cells (or wireless coverage areas) supported by one or more base units 121. In various embodiments, the transceiver 1325 is operable on unlicensed spectrum. Moreover, the transceiver 1325 may include multiple UE panel supporting one or more beams. Additionally, the transceiver 1325 may support at least one network interface 1340 and/or application interface 1345. The application interface(s) 1345 may support one or more APIs. The network interface(s) 1340 may support 3GPP reference points, such as Uu, N1, PC5, etc. Other network interfaces 1340 may be supported, as understood by one of ordinary skill in the art.

The processor 1305, in one embodiment, may include any known controller capable of executing computer-readable instructions and/or capable of performing logical operations. For example, the processor 1305 may be a microcontroller, a microprocessor, a CPU, a graphics processing unit (“GPU”), an auxiliary processing unit, a field programmable gate array (“FPGA”), or similar programmable controller. In some embodiments, the processor 1305 executes instructions stored in the memory 1310 to perform the methods and routines described herein. The processor 1305 is communicatively coupled to the memory 1310, the input device 1315, the output device 1320, and the transceiver 1325. In certain embodiments, the processor 1305 may include an application processor (also known as “main processor”) which manages application-domain and operating system (“OS”) functions and a baseband processor (also known as “baseband radio processor”) which manages radio functions.

The memory 1310, in one embodiment, is a computer readable storage medium. In some embodiments, the memory 1310 includes volatile computer storage media. For example, the memory 1310 may include a RAM, including dynamic RAM (“DRAM”), synchronous dynamic RAM (“SDRAM”), and/or static RAM (“SRAM”). In some embodiments, the memory 1310 includes non-volatile computer storage media. For example, the memory 1310 may include a hard disk drive, a flash memory, or any other suitable non-volatile computer storage device. In some embodiments, the memory 1310 includes both volatile and non-volatile computer storage media.

In some embodiments, the memory 1310 stores data related to CSI reporting for multiple transmit/receive points and frequency division duplex reciprocity. For example, the memory 1310 may store various parameters, panel/beam configurations, resource assignments, policies, and the like as described above. In certain embodiments, the memory 1310 also stores program code and related data, such as an operating system or other controller algorithms operating on the user equipment apparatus 1300.

The input device 1315, in one embodiment, may include any known computer input device including a touch panel, a button, a keyboard, a stylus, a microphone, or the like. In some embodiments, the input device 1315 may be integrated with the output device 1320, for example, as a touchscreen or similar touch-sensitive display. In some embodiments, the input device 1315 includes a touchscreen such that text may be input using a virtual keyboard displayed on the touchscreen and/or by handwriting on the touchscreen. In some embodiments, the input device 1315 includes two or more different devices, such as a keyboard and a touch panel.

The output device 1320, in one embodiment, is designed to output visual, audible, and/or haptic signals. In some embodiments, the output device 1320 includes an electronically controllable display or display device capable of outputting visual data to a user. For example, the output device 1320 may include, but is not limited to, an LCD display, an LED display, an OLED display, a projector, or similar display device capable of outputting images, text, or the like to a user. As another, non-limiting, example, the output device 1320 may include a wearable display separate from, but communicatively coupled to, the rest of the user equipment apparatus 1300, such as a smart watch, smart glasses, a heads-up display, or the like. Further, the output device 1320 may be a component of a smart phone, a personal digital assistant, a television, a table computer, a notebook (laptop) computer, a personal computer, a vehicle dashboard, or the like.

In certain embodiments, the output device 1320 includes one or more speakers for producing sound. For example, the output device 1320 may produce an audible alert or notification (e.g., a beep or chime). In some embodiments, the output device 1320 includes one or more haptic devices for producing vibrations, motion, or other haptic feedback. In some embodiments, all, or portions of the output device 1320 may be integrated with the input device 1315. For example, the input device 1315 and output device 1320 may form a touchscreen or similar touch-sensitive display. In other embodiments, the output device 1320 may be located near the input device 1315.

The transceiver 1325 communicates with one or more network functions of a mobile communication network via one or more access networks. The transceiver 1325 operates under the control of the processor 1305 to transmit messages, data, and other signals and also to receive messages, data, and other signals. For example, the processor 1305 may selectively activate the transceiver 1325 (or portions thereof) at particular times in order to send and receive messages.

The transceiver 1325 includes at least transmitter 1330 and at least one receiver 1335. One or more transmitters 1330 may be used to provide UL communication signals to a base unit 121, such as the UL transmissions described herein. Similarly, one or more receivers 1335 may be used to receive DL communication signals from the base unit 121, as described herein. Although only one transmitter 1330 and one receiver 1335 are illustrated, the user equipment apparatus 1300 may have any suitable number of transmitters 1330 and receivers 1335. Further, the transmitter(s) 1330 and the receiver(s) 1335 may be any suitable type of transmitters and receivers. In one embodiment, the transceiver 1325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1325, transmitters 1330, and receivers 1335 may be implemented as physically separate components that access a shared hardware resource and/or software resource, such as for example, the network interface 1340.

In various embodiments, one or more transmitters 1330 and/or one or more receivers 1335 may be implemented and/or integrated into a single hardware component, such as a multi-transceiver chip, a system-on-a-chip, an ASIC, or other type of hardware component. In certain embodiments, one or more transmitters 1330 and/or one or more receivers 1335 may be implemented and/or integrated into a multi-chip module. In some embodiments, other components such as the network interface 1340 or other hardware components/circuits may be integrated with any number of transmitters 1330 and/or receivers 1335 into a single chip. In such embodiment, the transmitters 1330 and receivers 1335 may be logically configured as a transceiver 1325 that uses one more common control signals or as modular transmitters 1330 and receivers 1335 implemented in the same hardware chip or in a multi-chip module.

In one embodiment, the transceiver 1325 receives, from a network, a CSI reporting setting associated with one or more CSI resource settings and receives, from one or more transmission points in the network, one or more NZP CSI-RS resources for channel measurement.

In on embodiment, the processor 1305 generates a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis. In one embodiment, the transceiver 1325 transmits the generated CSI report to the network.

In one embodiment, the set of CSI indicator types comprises one or more of a CRI, a RI, a precoder matrix indicator (“PMI”), a LI, or a CQI.

In one embodiment, the joint transmission hypothesis corresponds to a transmission from two network nodes, the first single-point transmission hypothesis corresponds to a first transmission from a first network node, and the second single-point transmission hypothesis corresponds to a second transmission from a second network node.

In one embodiment, the joint transmission hypothesis is associated with a pair of CSI-RS resources for channel measurement, the first single-point transmission hypothesis is associated with a first CSI-RS resource for channel measurement, and the second single-point transmission hypothesis is associated with a second CSI-RS resource for channel measurement.

In one embodiment, the generated CSI report further comprises CSI corresponding to a subset of the joint transmission hypothesis, the first single-point transmission hypothesis, and the second single-point transmission hypothesis.

In one embodiment, the CSI report comprises one segment and the CSI corresponding to the joint transmission hypothesis in the one segment is ordered according to at least a subset of the following order: CRI corresponding to the joint transmission hypothesis, RI corresponding to the joint transmission hypothesis, two layer indicators corresponding to the joint transmission hypothesis, wideband PMI of a first of two PMIs corresponding to a first network node of the two network nodes of the joint transmission hypothesis, and wideband PMI of a second of two PMIs corresponding to a second network node of the two network nodes of the joint transmission hypothesis.

In one embodiment, the CSI report comprises three segments, a first segment corresponding to a first part of two parts of the CSI report, a second segment corresponding to a wideband sub-part of a second part of the two parts of the CSI report, and a third segment corresponding to a subband sub-part of the second part of the two parts of the CSI report.

In one embodiment, the first part of the two parts of the CSI report comprises CSI that is mapped according to at least a subset of the following order: CRI corresponding to the joint transmission hypothesis, RI corresponding to the joint transmission hypothesis, wideband CQI corresponding to the joint transmission hypothesis, subband CQI corresponding to the joint transmission hypothesis, CRI corresponding to at least one of the two single transmission hypotheses, and RI corresponding to at least one of the two single transmission hypotheses.

In one embodiment, the first of two parts of the CSI report further comprises

wideband CQI corresponding to at least one of the two single transmission hypotheses.

In one embodiment, the wideband sub-part of the second part of the two parts of the CSI report comprises CSI that is mapped according to at least a subset of the following order: two layer indicators (“LIs”) corresponding to the joint transmission hypothesis, wideband PMI of a first of two PMIs corresponding to a first network node of the two network nodes of the joint transmission hypothesis, wideband PMI of a second of two PMIs corresponding to a second network node of the two network nodes of the joint transmission hypothesis, wideband CQI corresponding to the first single transmission hypothesis, LI corresponding to the first single transmission hypothesis, wideband PMI corresponding to the first single transmission hypothesis, wideband CQI corresponding to the second single transmission hypothesis, LI corresponding to the second single transmission hypothesis, and wideband PMI corresponding to the second single transmission hypothesis.

In one embodiment, the subband sub-part of the second part comprises CSI corresponding to even subbands for the joint transmission hypothesis, the first single-point transmission hypothesis, and the second single-point transmission hypothesis followed by CSI corresponding to odd subbands for the joint transmission hypothesis, the first single-point transmission hypothesis, and the second single-point transmission hypothesis.

In one embodiment, CSI corresponding to even subbands for the joint transmission hypothesis, the first single-point transmission hypothesis, and the second single-point transmission hypothesis is mapped according to at least a subset of the following order: PMI of even subbands of a first of two PMIs corresponding to a first network node of the two network nodes of the joint transmission hypothesis, PMI of even subbands of a second of two PMIs corresponding to a second network node of the two network nodes of the joint transmission hypothesis, differential CQI of even subbands corresponding to the first single transmission hypothesis, PMI of even subbands corresponding to the first single transmission hypothesis, differential CQI of even subbands corresponding to the second single transmission hypothesis, and PMI of even subbands corresponding to the second single transmission hypothesis.

In one embodiment, CSI corresponding to odd subbands for the joint transmission hypothesis, the first single-point transmission hypothesis, and the second single-point transmission hypothesis is mapped according to at least a subset of the following order: PMI of odd subbands of a first of two PMIs corresponding to a first network node of the two network nodes of the joint transmission hypothesis, PMI of odd subbands of a second of two PMIs corresponding to a second network node of the two network nodes of the joint transmission hypothesis, differential CQI of odd subbands corresponding to the first single transmission hypothesis, PMI of odd subbands corresponding to the first single transmission hypothesis, differential CQI of odd subbands corresponding to the second single transmission hypothesis, and PMI of odd subbands corresponding to the second single transmission hypothesis.

In one embodiment, a subband CQI is reported for either of the joint transmission hypothesis, the first single-point transmission hypothesis, and the second single-point transmission hypothesis in response to a configured CQI format indicator set to a wideband value and a subband PMI is reported for either of the joint transmission hypothesis, the first single-point transmission hypothesis, and the second single-point transmission hypothesis in response to a configured PMI format indicator set to a wideband value.

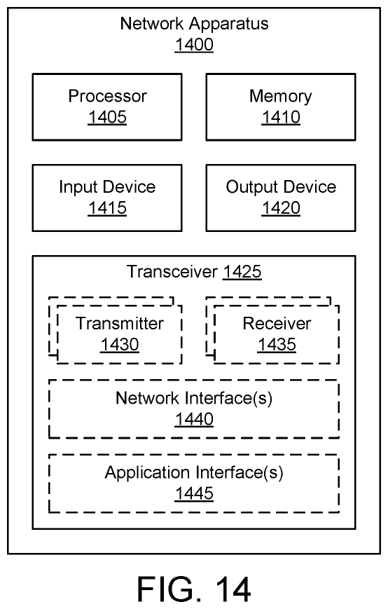

FIG. 14 depicts a network apparatus 1400 that may be used for CSI reporting for multiple transmit/receive points and frequency division duplex reciprocity, according to embodiments of the disclosure. In one embodiment, network apparatus 1400 may be one implementation of a RAN node, such as the base unit 121, the RAN node 210, or gNB, described above. Furthermore, the base network apparatus 1400 may include a processor 1405, a memory 1410, an input device 1415, an output device 1420, and a transceiver 1425.

In some embodiments, the input device 1415 and the output device 1420 are combined into a single device, such as a touchscreen. In certain embodiments, the network apparatus 1400 may not include any input device 1415 and/or output device 1420. In various embodiments, the network apparatus 1400 may include one or more of: the processor 1405, the memory 1410, and the transceiver 1425, and may not include the input device 1415 and/or the output device 1420.

As depicted, the transceiver 1425 includes at least one transmitter 1430 and at least one receiver 1435. Here, the transceiver 1425 communicates with one or more remote units 105. Additionally, the transceiver 1425 may support at least one network interface 1440 and/or application interface 1445. The application interface(s) 1445 may support one or more APIs. The network interface(s) 1440 may support 3GPP reference points, such as Uu, N1, N2 and N3. Other network interfaces 1440 may be supported, as understood by one of ordinary skill in the art.

The processor 1405, in one embodiment, may include any known controller capable of executing computer-readable instructions and/or capable of performing logical operations. For example, the processor 1405 may be a microcontroller, a microprocessor, a CPU, a GPU, an auxiliary processing unit, a FPGA, or similar programmable controller. In some embodiments, the processor 1405 executes instructions stored in the memory 1410 to perform the methods and routines described herein. The processor 1405 is communicatively coupled to the memory 1410, the input device 1415, the output device 1420, and the transceiver 1425. In certain embodiments, the processor 805 may include an application processor (also known as “main processor”) which manages application-domain and operating system (“OS”) functions and a baseband processor (also known as “baseband radio processor”) which manages radio function.

In various embodiments, the network apparatus 1400 is a RAN node (e.g., gNB) that includes a transceiver 1425 that sends, to a UE device, an indication that CSI corresponding to multiple transmit/receives points (“TRPs”) is to be reported and receives at least one CSI report from the UE corresponding to one or more of the multiple TRPs, the CSI report generated according to the CSI reporting configuration, the at least one CSI report comprising a CRI.

The memory 1410, in one embodiment, is a computer readable storage medium. In some embodiments, the memory 1410 includes volatile computer storage media. For example, the memory 1410 may include a RAM, including dynamic RAM (“DRAM”), synchronous dynamic RAM (“SDRAM”), and/or static RAM (“SRAM”). In some embodiments, the memory 1410 includes non-volatile computer storage media. For example, the memory 1410 may include a hard disk drive, a flash memory, or any other suitable non-volatile computer storage device. In some embodiments, the memory 1410 includes both volatile and non-volatile computer storage media.

In some embodiments, the memory 1410 stores data related to CSI reporting for multiple transmit/receive points and frequency division duplex reciprocity. For example, the memory 1410 may store parameters, configurations, resource assignments, policies, and the like, as described above. In certain embodiments, the memory 1410 also stores program code and related data, such as an operating system or other controller algorithms operating on the network apparatus 1400.

The input device 1415, in one embodiment, may include any known computer input device including a touch panel, a button, a keyboard, a stylus, a microphone, or the like. In some embodiments, the input device 1415 may be integrated with the output device 1420, for example, as a touchscreen or similar touch-sensitive display. In some embodiments, the input device 1415 includes a touchscreen such that text may be input using a virtual keyboard displayed on the touchscreen and/or by handwriting on the touchscreen. In some embodiments, the input device 1415 includes two or more different devices, such as a keyboard and a touch panel.

The output device 1420, in one embodiment, is designed to output visual, audible, and/or haptic signals. In some embodiments, the output device 1420 includes an electronically controllable display or display device capable of outputting visual data to a user. For example, the output device 1420 may include, but is not limited to, an LCD display, an LED display, an OLED display, a projector, or similar display device capable of outputting images, text, or the like to a user. As another, non-limiting, example, the output device 1420 may include a wearable display separate from, but communicatively coupled to, the rest of the network apparatus 1400, such as a smart watch, smart glasses, a heads-up display, or the like. Further, the output device 1420 may be a component of a smart phone, a personal digital assistant, a television, a table computer, a notebook (laptop) computer, a personal computer, a vehicle dashboard, or the like.

In certain embodiments, the output device 1420 includes one or more speakers for producing sound. For example, the output device 1420 may produce an audible alert or notification (e.g., a beep or chime). In some embodiments, the output device 1420 includes one or more haptic devices for producing vibrations, motion, or other haptic feedback. In some embodiments, all, or portions of the output device 1420 may be integrated with the input device 1415. For example, the input device 1415 and output device 1420 may form a touchscreen or similar touch-sensitive display. In other embodiments, the output device 1420 may be located near the input device 1415.

The transceiver 1425 includes at least transmitter 1430 and at least one receiver 1435. One or more transmitters 1430 may be used to communicate with the UE, as described herein. Similarly, one or more receivers 1435 may be used to communicate with network functions in the NPN, PLMN and/or RAN, as described herein. Although only one transmitter 1430 and one receiver 1435 are illustrated, the network apparatus 1400 may have any suitable number of transmitters 1430 and receivers 1435. Further, the transmitter(s) 1430 and the receiver(s) 1435 may be any suitable type of transmitters and receivers.

In one embodiment, the transceiver 1425 transmits, to a UE, a CSI reporting setting associated with one or more CSI resource settings. In one embodiment, the transceiver transmits, to the UE from one or more transmission points, one or more NZP CSI-RS resources for channel measurement. In one embodiment, the transceiver receives, from the UE, a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.

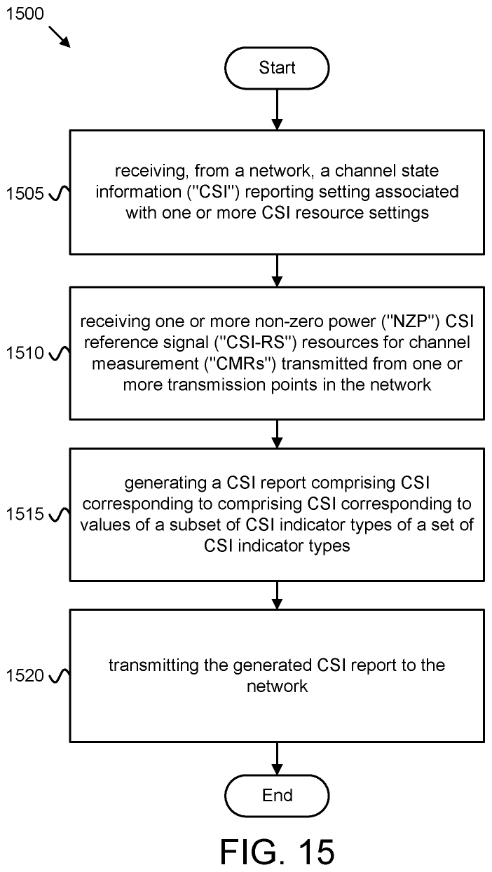

FIG. 15 is a flowchart diagram of a method 1500 for generating a UCI bit sequence for CSI reporting under multi-TRP transmission. The method 1500 may be performed by a UE as described herein, for example, the remote unit 105, the UE 205 and/or the user equipment apparatus 1300. In some embodiments, the method 1500 may be performed by a processor executing program code, for example, a microcontroller, a microprocessor, a CPU, a GPU, an auxiliary processing unit, a FPGA, or the like.

The method 1500, in one embodiment, includes receiving 1505, from a network, a CSI reporting setting associated with one or more CSI resource settings. In one embodiment, the method 1500 includes receiving 1510, from one or more transmission points in the network, one or more NZP CSI reference signal (“CSI-RS”) resources for channel measurement. In one embodiment, the method 1500 includes generating 1515 a CSI report comprising CSI corresponding to at least a subset of CSI indicator types. In one embodiment, the method 1500 includes transmitting 1520 the generated CSI report to the network. The method 1500 ends.

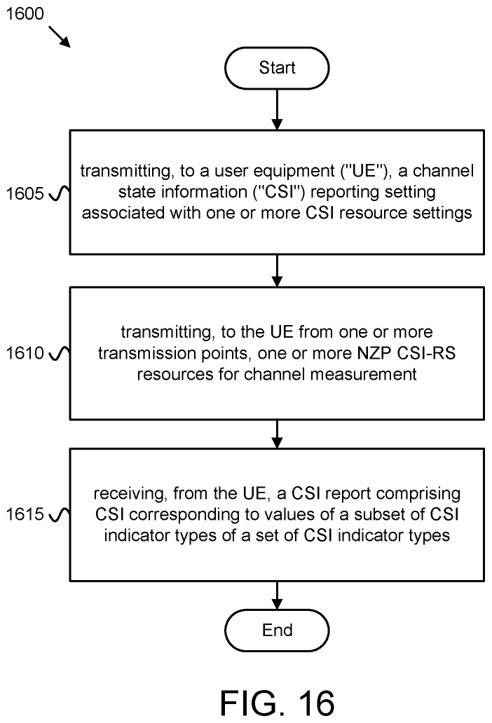

FIG. 16 is a flowchart diagram of a method 1600 for generating a UCI bit sequence for CSI reporting under multi-TRP transmission. The method 1600 may be performed by a network device described herein, for example, a gNB, a base station, and/or the network equipment apparatus 1400. In some embodiments, the method 1600 may be performed by a processor executing program code, for example, a microcontroller, a microprocessor, a CPU, a GPU, an auxiliary processing unit, a FPGA, or the like.

In one embodiment, the method 1600 transmits 1605, to a UE, a CSI reporting setting associated with one or more CSI resource settings. In one embodiment, the method 1600 transmits 1610, to the UE from one or more transmission points, one or more NZP CSI-RS resources for channel measurement. In one embodiment, the method 1600 receives 1615, from the UE, a CSI report comprising CSI corresponding to at least a subset of CSI indicator types. The method 1600 ends.

In one embodiment, a first apparatus for generating a UCI bit sequence for CSI reporting under multi-TRP transmission may be embodied as a UE as described herein, for example, the remote unit 105, the UE 205 and/or the user equipment apparatus 1300. In some embodiments, the first apparatus may include a processor executing program code, for example, a microcontroller, a microprocessor, a CPU, a GPU, an auxiliary processing unit, a FPGA, or the like

The first apparatus, in one embodiment, includes a transceiver that receives, from a network, a CSI reporting setting associated with one or more CSI resource settings and receives, from one or more transmission points in the network, one or more NZP CSI-RS resources for channel measurement.

In on embodiment, the first apparatus includes a processor that generates a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis. In one embodiment, the transceiver transmits the generated CSI report to the network.

In one embodiment, the set of CSI indicator types comprises one or more of a CRI, a RI, a PMI, a LI, or a CQI.

In one embodiment, the joint transmission hypothesis corresponds to a transmission from two network nodes, the first single-point transmission hypothesis corresponds to a first transmission from a first network node, and the second single-point transmission hypothesis corresponds to a second transmission from a second network node.

In one embodiment, the joint transmission hypothesis is associated with a pair of CSI-RS resources for channel measurement, the first single-point transmission hypothesis is associated with a first CSI-RS resource for channel measurement, and the second single-point transmission hypothesis is associated with a second CSI-RS resource for channel measurement.

In one embodiment, the generated CSI report further comprises CSI corresponding to a subset of the joint transmission hypothesis, the first single-point transmission hypothesis, and the second single-point transmission hypothesis.

In one embodiment, the CSI report comprises one segment and the CSI corresponding to the joint transmission hypothesis in the one segment is ordered according to at least a subset of the following order: CRI corresponding to the joint transmission hypothesis, RI corresponding to the joint transmission hypothesis, two layer indicators corresponding to the joint transmission hypothesis, wideband PMI of a first of two PMIs corresponding to a first network node of the two network nodes of the joint transmission hypothesis, and wideband PMI of a second of two PMIs corresponding to a second network node of the two network nodes of the joint transmission hypothesis.

In one embodiment, the CSI report comprises three segments, a first segment corresponding to a first part of two parts of the CSI report, a second segment corresponding to a wideband sub-part of a second part of the two parts of the CSI report, and a third segment corresponding to a subband sub-part of the second part of the two parts of the CSI report.

In one embodiment, the first part of the two parts of the CSI report comprises CSI that is mapped according to at least a subset of the following order: CRI corresponding to the joint transmission hypothesis, RI corresponding to the joint transmission hypothesis, wideband CQI corresponding to the joint transmission hypothesis, subband CQI corresponding to the joint transmission hypothesis, CRI corresponding to at least one of the two single transmission hypotheses, and RI corresponding to at least one of the two single transmission hypotheses.

In one embodiment, the first of two parts of the CSI report further comprises wideband CQI corresponding to at least one of the two single transmission hypotheses.

In one embodiment, the wideband sub-part of the second part of the two parts of the CSI report comprises CSI that is mapped according to at least a subset of the following order: two layer indicators (“LIs”) corresponding to the joint transmission hypothesis, wideband PMI of a first of two PMIs corresponding to a first network node of the two network nodes of the joint transmission hypothesis, wideband PMI of a second of two PMIs corresponding to a second network node of the two network nodes of the joint transmission hypothesis, wideband CQI corresponding to the first single transmission hypothesis, LI corresponding to the first single transmission hypothesis, wideband PMI corresponding to the first single transmission hypothesis, wideband CQI corresponding to the second single transmission hypothesis, LI corresponding to the second single transmission hypothesis, and wideband PMI corresponding to the second single transmission hypothesis.

In one embodiment, the subband sub-part of the second part comprises CSI corresponding to even subbands for the joint transmission hypothesis, the first single-point transmission hypothesis, and the second single-point transmission hypothesis followed by CSI corresponding to odd subbands for the joint transmission hypothesis, the first single-point transmission hypothesis, and the second single-point transmission hypothesis.

In one embodiment, CSI corresponding to even subbands for the joint transmission hypothesis, the first single-point transmission hypothesis, and the second single-point transmission hypothesis is mapped according to at least a subset of the following order: PMI of even subbands of a first of two PMIs corresponding to a first network node of the two network nodes of the joint transmission hypothesis, PMI of even subbands of a second of two PMIs corresponding to a second network node of the two network nodes of the joint transmission hypothesis, differential CQI of even subbands corresponding to the first single transmission hypothesis, PMI of even subbands corresponding to the first single transmission hypothesis, differential CQI of even subbands corresponding to the second single transmission hypothesis, and PMI of even subbands corresponding to the second single transmission hypothesis.

In one embodiment, CSI corresponding to odd subbands for the joint transmission hypothesis, the first single-point transmission hypothesis, and the second single-point transmission hypothesis is mapped according to at least a subset of the following order: PMI of odd subbands of a first of two PMIs corresponding to a first network node of the two network nodes of the joint transmission hypothesis, PMI of odd subbands of a second of two PMIs corresponding to a second network node of the two network nodes of the joint transmission hypothesis, differential CQI of odd subbands corresponding to the first single transmission hypothesis, PMI of odd subbands corresponding to the first single transmission hypothesis, differential CQI of odd subbands corresponding to the second single transmission hypothesis, and PMI of odd subbands corresponding to the second single transmission hypothesis.

In one embodiment, a subband CQI is reported for either of the joint transmission hypothesis, the first single-point transmission hypothesis, and the second single-point transmission hypothesis in response to a configured CQI format indicator set to a wideband value and a subband PMI is reported for either of the joint transmission hypothesis, the first single-point transmission hypothesis, and the second single-point transmission hypothesis in response to a configured PMI format indicator set to a wideband value.

In one embodiment, a first method for generating a UCI bit sequence for CSI reporting under multi-TRP transmission may be performed by a UE as described herein, for example, the remote unit 105, the UE 205 and/or the user equipment apparatus 1300. In some embodiments, the first method may be performed by a processor executing program code, for example, a microcontroller, a microprocessor, a CPU, a GPU, an auxiliary processing unit, a FPGA, or the like.

The first method, in one embodiment, receives, from a network, a CSI reporting setting associated with one or more CSI resource settings and receives, from one or more transmission points in the network, one or more NZP CSI-RS resources for channel measurement.

In on embodiment, the first method generates a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.

In one embodiment, the set of CSI indicator types comprises one or more of a CRI, a RI, a PMI, a LI, or a CQI.

In one embodiment, the joint transmission hypothesis corresponds to a transmission from two network nodes, the first single-point transmission hypothesis corresponds to a first transmission from a first network node, and the second single-point transmission hypothesis corresponds to a second transmission from a second network node.

In one embodiment, the joint transmission hypothesis is associated with a pair of CSI-RS resources for channel measurement, the first single-point transmission hypothesis is associated with a first CSI-RS resource for channel measurement, and the second single-point transmission hypothesis is associated with a second CSI-RS resource for channel measurement.

In one embodiment, the generated CSI report further comprises CSI corresponding to a subset of the joint transmission hypothesis, the first single-point transmission hypothesis, and the second single-point transmission hypothesis.

In one embodiment, the CSI report comprises one segment and the CSI corresponding to the joint transmission hypothesis in the one segment is ordered according to at least a subset of the following order: CRI corresponding to the joint transmission hypothesis, RI corresponding to the joint transmission hypothesis, two layer indicators corresponding to the joint transmission hypothesis, wideband PMI of a first of two PMIs corresponding to a first network node of the two network nodes of the joint transmission hypothesis, and wideband PMI of a second of two PMIs corresponding to a second network node of the two network nodes of the joint transmission hypothesis.

In one embodiment, the CSI report comprises three segments, a first segment corresponding to a first part of two parts of the CSI report, a second segment corresponding to a wideband sub-part of a second part of the two parts of the CSI report, and a third segment corresponding to a subband sub-part of the second part of the two parts of the CSI report.

In one embodiment, the first part of the two parts of the CSI report comprises CSI that is mapped according to at least a subset of the following order: CRI corresponding to the joint transmission hypothesis, RI corresponding to the joint transmission hypothesis, wideband CQI corresponding to the joint transmission hypothesis, subband CQI corresponding to the joint transmission hypothesis, CRI corresponding to at least one of the two single transmission hypotheses, and RI corresponding to at least one of the two single transmission hypotheses.

In one embodiment, the first of two parts of the CSI report further comprises wideband CQI corresponding to at least one of the two single transmission hypotheses.

In one embodiment, the wideband sub-part of the second part of the two parts of the CSI report comprises CSI that is mapped according to at least a subset of the following order: two layer indicators (“LIs”) corresponding to the joint transmission hypothesis, wideband PMI of a first of two PMIs corresponding to a first network node of the two network nodes of the joint transmission hypothesis, wideband PMI of a second of two PMIs corresponding to a second network node of the two network nodes of the joint transmission hypothesis, wideband CQI corresponding to the first single transmission hypothesis, LI corresponding to the first single transmission hypothesis, wideband PMI corresponding to the first single transmission hypothesis, wideband CQI corresponding to the second single transmission hypothesis, LI corresponding to the second single transmission hypothesis, and wideband PMI corresponding to the second single transmission hypothesis.

In one embodiment, the subband sub-part of the second part comprises CSI corresponding to even subbands for the joint transmission hypothesis, the first single-point transmission hypothesis, and the second single-point transmission hypothesis followed by CSI corresponding to odd subbands for the joint transmission hypothesis, the first single-point transmission hypothesis, and the second single-point transmission hypothesis.

In one embodiment, CSI corresponding to even subbands for the joint transmission hypothesis, the first single-point transmission hypothesis, and the second single-point transmission hypothesis is mapped according to at least a subset of the following order: PMI of even subbands of a first of two PMIs corresponding to a first network node of the two network nodes of the joint transmission hypothesis, PMI of even subbands of a second of two PMIs corresponding to a second network node of the two network nodes of the joint transmission hypothesis, differential CQI of even subbands corresponding to the first single transmission hypothesis, PMI of even subbands corresponding to the first single transmission hypothesis, differential CQI of even subbands corresponding to the second single transmission hypothesis, and PMI of even subbands corresponding to the second single transmission hypothesis.

In one embodiment, CSI corresponding to odd subbands for the joint transmission hypothesis, the first single-point transmission hypothesis, and the second single-point transmission hypothesis is mapped according to at least a subset of the following order: PMI of odd subbands of a first of two PMIs corresponding to a first network node of the two network nodes of the joint transmission hypothesis, PMI of odd subbands of a second of two PMIs corresponding to a second network node of the two network nodes of the joint transmission hypothesis, differential CQI of odd subbands corresponding to the first single transmission hypothesis, PMI of odd subbands corresponding to the first single transmission hypothesis, differential CQI of odd subbands corresponding to the second single transmission hypothesis, and PMI of odd subbands corresponding to the second single transmission hypothesis.

In one embodiment, a subband CQI is reported for either of the joint transmission hypothesis, the first single-point transmission hypothesis, and the second single-point transmission hypothesis in response to a configured CQI format indicator set to a wideband value and a subband PMI is reported for either of the joint transmission hypothesis, the first single-point transmission hypothesis, and the second single-point transmission hypothesis in response to a configured PMI format indicator set to a wideband value.

In one embodiment, a second apparatus for generating a UCI bit sequence for CSI reporting under multi-TRP transmission may be embodied as a network device described herein, for example, a gNB, a base station, and/or the network equipment apparatus 1400. In some embodiments, the second apparatus includes a processor executing program code, for example, a microcontroller, a microprocessor, a CPU, a GPU, an auxiliary processing unit, a FPGA, or the like.

In one embodiment, the second apparatus includes a transceiver that transmits, to a UE, a CSI reporting setting associated with one or more CSI resource settings. In one embodiment, the transceiver transmits, to the UE from one or more transmission points, one or more NZP CSI-RS resources for channel measurement. In one embodiment, the transceiver receives, from the UE, a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.

In one embodiment, a second method for generating a UCI bit sequence for CSI reporting under multi-TRP transmission may be performed by a network device described herein, for example, a gNB, a base station, and/or the network equipment apparatus 1400. In some embodiments, the second method may be performed by a processor executing program code, for example, a microcontroller, a microprocessor, a CPU, a GPU, an auxiliary processing unit, a FPGA, or the like.

In one embodiment, the second method transmits, to a UE, a CSI reporting setting associated with one or more CSI resource settings. In one embodiment, the transceiver transmits, to the UE from one or more transmission points, one or more NZP CSI-RS resources for channel measurement. In one embodiment, the transceiver receives, from the UE, a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a transceiver that:
receives, from a network, a channel state information (“CSI”) reporting setting associated with one or more CSI resource settings; and
receives, from one or more transmission points in the network, one or more non-zero power (“NZP”) CSI reference signal (“CSI-RS”) resources for channel measurement; and
a processor that generates a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis,
wherein the transceiver transmits the generated CSI report to the network.

2. The apparatus of claim 1, wherein the set of CSI indicator types comprises one or more of a CSI-RS indicator (“CRI”), a rank indicator (“RI”), a precoder matrix indicator (“PMI”), a layer indicator (“LI”), or a channel quality indicator (“CQI”).

3. The apparatus of claim 1, wherein the joint transmission hypothesis corresponds to a transmission from two network nodes, the first single-point transmission hypothesis corresponds to a first transmission from a first network node, and the second single-point transmission hypothesis corresponds to a second transmission from a second network node.

4. The apparatus of claim 1, wherein:
the joint transmission hypothesis is associated with a pair of CSI-RS resources for channel measurement:
the first single-point transmission hypothesis is associated with a first CSI-RS resource for channel measurement; and
the second single-point transmission hypothesis is associated with a second CSI-RS resource for channel measurement.

5. The apparatus of claim 1, wherein the generated CSI report further comprises CSI corresponding to a subset of the joint transmission hypothesis, the first single-point transmission hypothesis, and the second single-point transmission hypothesis.

6. The apparatus of claim 1, wherein the CSI report comprises one segment and the CSI corresponding to the joint transmission hypothesis in the one segment is ordered according to at least a subset of the following order:
CSI-RS indicator (“CRI”) corresponding to the joint transmission hypothesis:
rank indicator (“RI”) corresponding to the joint transmission hypothesis:
two layer indicators corresponding to the joint transmission hypothesis:
wideband precoder matrix indicator (“PMI”) of a first of two PMIs corresponding to a first network node of the two network nodes of the joint transmission hypothesis:
wideband PMI of a second of two PMIs corresponding to a second network node of the two network nodes of the joint transmission hypothesis; and
wideband CQI corresponding to the joint transmission hypothesis.

7. The apparatus of claim 1, wherein the CSI report comprises three segments, a first segment corresponding to a first part of two parts of the CSI report, a second segment corresponding to a wideband sub-part of a second part of the two parts of the CSI report, and a third segment corresponding to a subband sub-part of the second part of the two parts of the CSI report.

8. The apparatus of claim 7, wherein the first part of the two parts of the CSI report comprises CSI that is mapped according to at least a subset of the following order:
CSI-RS indicator (“CRI”) corresponding to the joint transmission hypothesis;
rank indicator (“RI”) corresponding to the joint transmission hypothesis:
wideband channel quality indicator (“CQI”) corresponding to the joint transmission hypothesis:
subband differential CQI corresponding to the joint transmission hypothesis:
CRI corresponding to at least one of the two single transmission hypotheses; and
RI corresponding to at least one of the two single transmission hypotheses.

9. The apparatus of claim 8, wherein the first of two parts of the CSI report further comprises wideband CQI corresponding to at least one of the two single transmission hypotheses.

10. The apparatus of claim 7, wherein the wideband sub-part of the second part of the two parts of the CSI report comprises CSI that is mapped according to at least a subset of the following order:
two layer indicators (“LIs”) corresponding to the joint transmission hypothesis;
wideband PMI of a first of two PMIs corresponding to a first network node of the two network nodes of the joint transmission hypothesis;
wideband PMI of a second of two PMIs corresponding to a second network node of the two network nodes of the joint transmission hypothesis:
wideband CQI corresponding to the first single transmission hypothesis;
LI corresponding to the first single transmission hypothesis:
wideband PMI corresponding to the first single transmission hypothesis;
wideband CQI corresponding to the second single transmission hypothesis:
LI corresponding to the second single transmission hypothesis; and
wideband PMI corresponding to the second single transmission hypothesis.

11. The apparatus of claim 7, wherein the subband sub-part of the second part comprises CSI corresponding to even subbands for the joint transmission hypothesis, the first single-point transmission hypothesis, and the second single-point transmission hypothesis followed by CSI corresponding to odd subbands for the joint transmission hypothesis, the first single-point transmission hypothesis, and the second single-point transmission hypothesis.

12. The apparatus of claim 11, wherein CSI corresponding to even subbands for the joint transmission hypothesis, the first single-point transmission hypothesis, and the second single-point transmission hypothesis is mapped according to at least a subset of the following order:
PMI of even subbands of a first of two PMIs corresponding to a first network node of the two network nodes of the joint transmission hypothesis:
PMI of even subbands of a second of two PMIs corresponding to a second network node of the two network nodes of the joint transmission hypothesis:
subband differential CQI of even subbands corresponding to the first single transmission hypothesis:
PMI of even subbands corresponding to the first single transmission hypothesis:
subband differential CQI of even subbands corresponding to the second single transmission hypothesis; and
PMI of even subbands corresponding to the second single transmission hypothesis.

13. The apparatus of claim 11, wherein CSI corresponding to odd subbands for the joint transmission hypothesis, the first single-point transmission hypothesis, and the second single-point transmission hypothesis is mapped according to at least a subset of the following order:
PMI of odd subbands of a first of two PMIs corresponding to a first network node of the two network nodes of the joint transmission hypothesis:
PMI of odd subbands of a second of two PMIs corresponding to a second network node of the two network nodes of the joint transmission hypothesis:
subband differential CQI of odd subbands corresponding to the first single transmission hypothesis:
PMI of odd subbands corresponding to the first single transmission hypothesis:
subband differential CQI of odd subbands corresponding to the second single transmission hypothesis; and
PMI of odd subbands corresponding to the second single transmission hypothesis.

14. A method of a user equipment (“UE”), comprising:
receiving, from a network, a channel state information (“CSI”) reporting setting associated with one or more CSI resource settings; and
receiving, from one or more transmission points in the network, one or more non-zero power (“NZP”) CSI reference signal (“CSI-RS”) resources for channel measurement;
generating a CSI report comprising CSI corresponding to values a subset of CSI indicator types of a set of CSI indicator types, each value of the subset of CSI indicator types of the set of CSI indicator types corresponding to at least one of a joint transmission hypothesis, a first single-point transmission hypothesis, and a second single-point transmission hypothesis, the CSI report comprising at least one segment comprising the values of the subset of CSI indicator types of the set of CSI indicator types that are ordered in an order of the joint transmission hypothesis, the first single-point transmission hypothesis, and the second single-point transmission hypothesis; and
transmitting the generated CSI report to the network.

15. A network node apparatus, comprising:
a transceiver that:
transmits, to a user equipment (“UE”), a channel state information (“CSI”) reporting setting associated with one or more CSI resource settings;
transmits, to the UE from one or more transmission points, one or more non-zero power (“NZP”) CSI reference signal (“CSI-RS”) resources for channel measurement; and
receives, from the UE, a CSI report comprising CSI corresponding to values of a subset of CSI indicator types of a set of CSI indicator types, each value of the subset of CSI indicator types of the set of CSI indicator types corresponding to at least one transmission hypothesis of a joint transmission hypothesis, a first single-point transmission hypothesis, and a second single-point transmission hypothesis, the CSI report comprising at least one segment comprising the values of the subset of the CSI indicator types of the set of CSI indicator types that are ordered in an order of the joint transmission hypothesis, the first single-point transmission hypothesis, and the second single-point transmission hypothesis.
